(19) United States
(12) Patent Application Publication
(10) Pub. No.: US 2022/0169872 A1
(43) Pub. Date: Jun. 2, 2022

(54) AQUEOUS DISPERSION, METHOD OF MANUFACTURING AQUEOUS DISPERSION, AND INK

(71) Applicants: Ryo MIYAKOSHI, Kanagawa (JP); Takuya Yamazaki, Kanagawa (JP); Chikako Hatta, Kanagawa (JP)

(72) Inventors: Ryo MIYAKOSHI, Kanagawa (JP); Takuya Yamazaki, Kanagawa (JP); Chikako Hatta, Kanagawa (JP)

(73) Assignee: Ricoh Company, Ltd., Tokyo (JP)

(21) Appl. No.: 17/534,601

(22) Filed: Nov. 24, 2021

(30) Foreign Application Priority Data
Nov. 30, 2020 (JP) 2020-198702
Sep. 28, 2021 (JP) 2021-157974
Nov. 1, 2021 (JP) 2021-178852

(51) Int. Cl. C09D 11/104; C08J 3/05; C08K 3/04

(52) U.S. Cl. CPC C09D 11/104; C08J 2367/02; C08K 3/04; C08J 3/05

(57) ABSTRACT

An aqueous dispersion contains water and resin particles containing a resin, wherein the resin particles contains pigment-enclosed resin particles containing an inorganic pigment enclosed in the resin, wherein the pigment-enclosed resin particles have a 50 percent cumulative volume particle diameter (D50) of from 40 to 200 nm and a 90 percent cumulative volume particle diameter (D90) of from 70 to 500 nm as measured by laser diffraction scattering, wherein the pigment-enclosed resin particles have an average aspect ratio of from 1.0 to 1.5.

### CROSS-REFERENCE TO RELATED APPLICATIONS

This patent application is based on and claims priority pursuant to 35 U.S.C. § 119 to Japanese Patent Application Nos. 2020-198702, 2021-157974, and 2021-178852, filed on Nov. 30, 2020, Sep. 28, 2021, and Nov. 1, 2021, respectively, in the Japan Patent Office, the entire disclosures of which are hereby incorporated by reference herein.

### BACKGROUND

### Technical Field

The present disclosure is related to an aqueous dispersion, a method of manufacturing an aqueous dispersion, and an ink.

### Description of the Related Art

Since inkjet printing devices are relatively quiet, have low running costs, and are capable of printing color images with ease, they are now widely used at home to output digital information. Inkjet technologies have been appealing in commercial and industrial as well as home settings. In commercial and industrial applications, inkjet printing is required to achieve the image quality on par with that of typical offset printing for printing on coated paper having low ink absorbing property and non-ink-absorbing plastic media.

### SUMMARY

According to embodiments of the present disclosure, an aqueous dispersion is provided which contains resin particles containing a resin, wherein the resin particles contains water and pigment-enclosed resin particles containing an inorganic pigment enclosed in the resin, wherein the pigment-enclosed resin particles have a 50 percent cumulative volume particle diameter (D50) of from 40 to 200 nm and a 90 percent cumulative volume particle diameter (D90) of 3 0 from 70 to 500 nm as measured by laser diffraction scattering, wherein the pigment-enclosed resin particles have an average aspect ratio of from 1.0 to 1.5.

### BRIEF DESCRIPTION OF THE SEVERAL VIEWS OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a transmission electron microscope (TEM) image illustrating an aqueous dispersion containing pigment-enclosed resin particles produced in Example 1, which is described later;

FIG. 2 is a TEM image illustrating the aqueous dispersion produced in Comparative Example 6, which is described later;

FIG. 3 is a TEM image illustrating the ink produced in Comparative Example 6, which is described later; and

FIG. 4 is a schematic diagram illustrating an example of a printing device.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”, “an”, and “the” are intended to include the plural forms as well, unless the context clearly indicates otherwise.

Moreover, image forming, recording, printing, modeling, etc., in the present disclosure represent the same meaning, unless otherwise specified.

Embodiments of the present invention are described in detail below with reference to accompanying drawing(s). In describing embodiments illustrated in the drawing(s), specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

In common technologies, complete enclosure of pigments in resin particles is difficult. Since resin coating pigments is highly hydrophilic, it readily detaches from the surface of the pigments. Consequently, an aqueous dispersion containing a complex of pigments and resin is not stabilized well. In such a dispersion, the pigments are likely to agglomerate when dried with heat. This agglomeration prevents uniform dispersion of the pigments and degrades the surface roughness of a coated film, due to which the image density deteriorates in comparison with that achieved before drying with heat. The aqueous dispersion mentioned above thus fails to meet the image density required at the moment.

According to the present disclosure, an aqueous dispersion is provided which has excellent dispersion stability and creates images with high image density.

An embodiment of the present disclosure is an aqueous dispersion which contains resin particles containing a resin, wherein the resin particles contain pigment-enclosed resin particles containing an inorganic pigment enclosed in the resin, wherein the pigment-enclosed resin particles have a 50 percent cumulative volume particle diameter (D50) of from 40 to 200 nm and a 90 percent cumulative volume particle diameter (D90) of from 70 to 500 nm as measured by laser diffraction scattering, wherein the pigment-enclosed resin particles have an average aspect ratio of from 1.0 to 1.5.

The present embodiment of the present disclosure is a description for illustration purpose only and the present disclosure is not limited thereto.

### Aqueous Dispersion

The aqueous dispersion contains water and resin particles containing a resin. That aqueous dispersion may contain, a pigment dispersant, and an additive.

In an embodiment of the present disclosure, the aqueous dispersion is a mixture that contains resin particles as a dispersoid and water as a dispersion medium. Water has the highest mass proportion among the dispersion media.

In the present disclosure, the resin particles containing a resin, hereinafter referred to as resin particles, are particulate matter containing that resin as at least one element.

### Resin Particle

The resin particles are dispersed in a dispersion medium of the aqueous dispersion as described above; in other words, they are present in a form of an emulsion. Emulsion means the state in which particles are dispersed in water or ink. Those particles can be solid or liquid. The resin integrally encloses the pigment in some of the resin particles, which are referred to as pigment-enclosed resin particles.

The resin particles may contain a substance such as a pigment in addition to the resin. The resin particles include pigment-enclosed resin particles, in which the resin and the pigment are integrated in the particles and the pigment is enclosed in the resin, pigment-containing resin particles, in which the resin and the pigment are integrated in the particles and the pigment is partially exposed to the outside, and non-pigment-containing resin particles, which contain the resin but no pigment. “Enclosed” in the present disclosure means the state in which, in an observation region such that an image region observed by a transmission electron microscope (TEM), the material present inside is completely enclosed by the material present outside; in other words, the material inside is not exposed to the outside at all.

### Pigment-Enclosed Resin Particles

The pigment-enclosed resin particles are dispersed in a dispersion medium of the aqueous dispersion, that is, they are present in a form of an emulsion.

It is preferable that the pigment-enclosed resin particles in the present disclosure do not include a form in which pigments are not enclosed in resin pigments but dispersed in a dispersion medium or pigments partially exposed to the surface of resin particles. The pigment-enclosed resin particles are preferably spherical.

In the pigment-enclosed resin particles in the present disclosure, the pigment and the resin are integrated while the pigment is enclosed in the resin particles. It excludes resin-coated particles. Coated pigments and microcapsulated pigments have been proposed in Japanese unexamined published application Nos. 2016-196621, 2002-322396, 2019-099819, and 2005-120136. However, those are not forms of resin particles completely enclosing a pigment, which are different from the pigment-enclosed resin particles of the present disclosure.

Inclusion of the pigment-enclosed resin particles in an aqueous dispersion prevents the resin that enhances the dispersibility of a pigment from being detached from the pigment, thereby enhancing the dispersion stability of the pigment. This inclusion minimizes an increase of the surface roughness of an image resulting from aggregated pigments when the image created with ink containing an aqueous medium is dried with heat. Consequently, the degree of gloss of the image is enhanced. A resin that enhances the dispersibility of a pigment is generally and effectively prevented from detaching by increasing the ratio of the resin and decreasing the ratio of the pigment; however, it involves a problem of decreasing the image density of an image created with ink containing an aqueous dispersion. Since pigment-enclosed resin particles minimize this detachment, it is not necessary to decrease the ratio of the pigment, which also enhances the image density.

The resin particles may furthermore optionally include non-pigment-enclosed resin particles in addition to the pigment-enclosed resin particle. The proportion of the pigment-enclosed resin particles can be adjusted to suit to a particular application when such resin particles other than the pigment-enclosed resin particles are present. The proportion of the pigment-enclosed resin particles is obtained by: acquiring five or more images each having three or more particles having a size of 50 nm or greater; and calculating the ratio in number of the pigment-enclosed resin particles to the 50 nm or greater particles. The ratio is preferably 30 percent or higher and more preferably 50 percent or higher. It is preferable that two or more primary pigment particles be contained per pigment-enclosed resin particle. The image density (optical density) is enhanced as the pigment density in a particle increases. The pigment-enclosed resin particle can be observed with an instrument such as a transmission electron microscope (TEM).

One way of observing pigment-enclosed resin particles with a TEM is as follows: An aqueous dispersion containing pigment-enclosed resin particles is diluted with deionized water to obtain a liquid sample having a solid content concentration of 0.1 percent. Next, 1 μl of the liquid sample is placed on a hydrophillized-collodion-film attached mesh (Cu 150 mesh, manufactured by NISSIN EM CO., LTD.) using a micro pipette. Immediately thereafter, the liquid is absorbed by a filter paper cut in the shape of a triangle. Next, 1 μl of an Em stainer diluted with a factor of 10 is placed on the mesh. Immediately thereafter, the liquid is absorbed by a filter paper cut in the shape of a triangle. Subsequent to drying under a reduced pressure, the sample remaining on the mesh is observed with a TEM (JEM-2100F, manufactured by JEOL Ltd.) at an acceleration voltage of 200 kV and 40,000× magnification.

‘pigment-enclosed’ means that all the surface of a pigment is covered with a spherical resin particle. It is preferable that pigments unenclosed or partially exposed to the surface of resin particles be not present in the dispersion medium in an aqueous dispersion. Whether or not a pigment is enclosed can be checked with an instrument such as the TEM mentioned above.

‘all the surface of a pigment is covered’ means that the thickness of resin, that is, the length between the outer exterior (surface of a particle) of a pigment-enclosed resin particle and a pigment, is 5 nm or greater, preferably from 5 to 50 nm, and more preferably from 10 to 30 nm. The thickness of the resin is obtained by observing 10 or more pigment-enclosed resin particles by the observation method of a pigment-enclosed resin particle as described above using a TEM and arbitrarily measuring the length between the surface of each particle and a pigment followed by calculating the average.

The aspect ratio of a pigment-enclosed resin particle is obtained by image processing of an image of the pigment-enclosed resin particle using the TEM mentioned above. In fact, multiple images including pigment-enclosed resin particles are obtained in different fields of vision while changing observation points at randomly. Pigment-enclosed resin particles without overlapping other particles are extracted by digitization using image analysis software (ImageJ, created by National Institutes of Health) followed by particle analysis. The ratio of the major axis to the minor axis of the ellipse most approximate to a particle is determined as the aspect ratio. The aspect ratios of 20 particles are used to calculate the average thereof.

The degree of the enclosure of a pigment is evaluated by the pigment exposure ratio, by which pigments unenclosed but exposed are quantified. The pigment exposure ratio is calculated by using a scanning electron microscope (SEM). One way of calculating the pigment exposure ratio is as follows:

An aqueous dispersion containing pigment-enclosed resin particles having a solid content concentration of 10.75 percent by mass is prepared using deionized water; this aqueous dispersion is applied to coated paper (LumiArt Gloss 130) with a 0.15 mm bar coater followed by drying at 25 degrees C.; this dried coating film thus obtained is cut out and fixed onto a stub for SEM observation with carbon tape; and this fixed film without electroconductivity treatment is observed with an SEM (Merlin, manufactured by ZEISS) equipped with a reflected electron detector at an acceleration voltage of 0.75 kV and 2,000 to 20,000 x magnification. In this observation, exposed pigments are identified due to the contrast difference between carbon black and the resin in the SEM image attributable to the difference in the emission amount of reflected electrons.

The ratio (pigment exposure ratio) of the area of a pigment to the entire surface of the coated film at 20,000× magnification is preferably 8 percent or less and more preferably 5 percent or less to the entire area. The area of pigments in the entire surface of the coated film is obtained from a digitized SEM image. It is preferable to average three or more fields of vision. The pigment exposure ratio tends to be low when pigments are not possibly observed due to charge up under these observation conditions. In fact, charge up is likely to occur when the ratio is 3 percent or less.

By spherically covering two or more primary particles of pigments, the pigments are uniformly dispersed in coated film obtained after drying with heat and the surface roughness of the film can be reduced. The optical density of an image is enhanced resulting from this reduction in surface roughness. The surface roughness of coated film is preferably 20 nm or less, more preferably 10 nm or less, and furthermore preferably 5 nm or less. A surface roughness of 20 nm or less minimizes a decrease in image density (optical density) after drying with heat.

The surface roughness of the coated film mentioned above is calculated using a scanning probe microscope (SPM). One way of obtaining coated film is to: prepare an aqueous dispersion containing pigment-enclosed resin particles having a solid content concentration of 10.75 percent by mass using deionized water; apply the dispersion onto coated paper (LumiArt Gloss 130) with 0.15 mm bar coater; and dry the coated paper in an oven at 100 degrees C. for five minutes. This coated film is cut out and observed under the following conditions to calculate the surface roughness. The film is observed in three fields of view and the average of the surface roughness is obtained.
Instrument: SPM (DimensionIcon, manufactured by Bruker)
Cantilever: OMCL-AC240TS, manufactured by Olympus Corporation
Measurement mode: tapping mode
Observation region: 2 μm square

The 50 percent cumulative volume particle diameter (D50) of the pigment-enclosed resin particles is preferably from 40 to 200 nm, more preferably from 60 to 150 nm, and furthermore preferably from 70 to 100 nm. The 50 percent cumulative volume particle diameter (D50) is referred to as D50 and the 90 percent cumulative volume particle diameter (D90) is referred to as D90.

A D50 of 40 nm or greater reduces liquid viscosity, thereby enhancing dispersion stability. It also enhances the optical density by enclosing multiple primary pigment particles. A D50 of 200 nm or less minimizes particle sedimentation and enhances storage stability as particles. The D90 is preferably from 70 to 500 nm and more preferably 300 nm or less. A D90 of 70 nm or greater efficiently encloses pigments and a D90 of 500 nm or less minimizes sedimentation of particles, thereby enhancing the storage stability of particles. The dispersion stability of particles is significantly affected by the total frequency of particles having a diameter of from 1 to 50 μm in the volume frequency distribution. The total frequency of particles having a diameter of from 1 to 50 μm is preferably 10.0 percent or less, more preferably 5.0 percent or less, and furthermore preferably 1.0 percent or less. There is no particular limit to a device for evaluating the diameter of pigment-enclosed resin particles. It is preferable to measure D50, D90, and the total frequency of particles having a particle diameter of from 1 to 50 μm in the volume frequency distribution using a laser diffraction/scattering particle size distribution measuring device (LA-960, manufactured by HORIBA, Ltd.).

### Method of Manufacturing Aqueous Dispersion Containing Pigment-Enclosed Resin Particle

In the pigment-enclosed resin particles in the present disclosure, the pigment is enclosed in the resin. The method of manufacturing an aqueous dispersion containing pigment-enclosed resin particles is not particularly limited. It may include the following 1 to 4.

### Water-Immiscible Organic Solvent Not Contained

1. mixing a water-miscible organic solvent, a pigment, and optionally a pigment dispersant to obtain a pre-pigment dispersion having a D50 of from 30 to 120 nm;

2. mixing the pre-pigment dispersion with a resin to obtain a pigment-dispersed resin solution;

3. mixing the pigment-dispersed resin solution with water to obtain a liquid dispersion containing pigment-enclosed resin particles in which the pigment is enclosed in the resin; and 4. purging the liquid dispersion of the water-miscible organic solvent to obtain an aqueous dispersion containing pigment-enclosed resin particles.

### Water-Immiscible Organic Solvent Contained

1. mixing a water-miscible organic solvent, a water-immiscible organic solvent, a pigment, and optionally a pigment dispersant under a condition that a proportion of the water-miscible organic solvent to a total mass of the water-miscible organic solvent and the water-immiscible organic solvent is 30 percent by mass or greater to obtain a pre-pigment dispersion having a D50 of from 30 to 120 nm;

2. mixing the pre-pigment dispersion with a resin to obtain a pigment-dispersed resin solution;

3. mixing the pigment-dispersed resin solution with water to obtain a liquid dispersion containing pigment-enclosed resin particles; and

4. purging the liquid dispersion of the water-miscible organic solvent and the water-immiscible organic solvent to obtain an aqueous dispersion.

The water-miscible organic solvent can be dissolved in water at any ratio. Specific examples include, but are not limited to, alcohol-based solvents such as methanol, ethanol, propanol, isopropanol, tert-butyl alcohol, and ethylene glycol; ether-based solvents such as 1,2-dimethoxy ethane, tetrahydrofuran, and 1,4-dioxane; ketone-based organic solvents such as acetone; amine-based organic solvents such as pyridine, N-methyl pyrrolidone, triethylamine, and dimethyl formamide: and other organic solvents such as acetonitrile. The water-miscible organic solvent is not particularly limited and preferably a cyclic compound and more preferably a cyclic ether compound. Tetrahydrofuran is particularly preferable as the cyclic ether compound. A cyclic ether compound containing an antioxidant is generally usable. An aqueous dispersion preferably contains the same antioxidant as that contained in tetrahydrofuran. Examples of the antioxidant include, but are not limited to, phenol-based antioxidants and aromatic amine-based antioxidants. Dibutyl hydroxytoluene is preferable.

As the organic solvent, water-immiscible organic solvents can be used in addition to the water-miscible organic solvents unless they have an inadvertent impact on the solubility of a self-emulsifying resin. The proportion of the water-miscible organic solvent is preferably 30 percent by mass or greater, more preferably 60 percent by mass or greater, and furthermore preferably 90 percent by mass or greater to the total amount of the organic solvents. A proportion of 30 percent by mass or greater reduces the size of pigment-enclosed resin particles obtained by emulsification.

Water-immiscible organic solvents are not particularly limited.

Specific examples include, but are not limited to, butyl alcohol, diethyl alcohol, ethyl acetate, carbon tetrachloride, chloroform, dichloroethane, benzene, toluene, xylene, pentane, hexane, heptane, and methylethyl ketone.

Each of 1 to 4 mentioned above is described below in detail.

1

A pre-pigment dispersion is obtained in 1.

The pre-pigment dispersion obtained in 1 is obtained by dispersing a pigment in an organic solvent optionally with a pigment dispersant and other components followed by adjusting the particle diameter thereof. There is no particular limit to the device used in 1. It is preferable to use a disperser.

The organic solvent for use in the pre-pigment dispersion is preferably miscible with water and more preferable when capable of dissolving the resin in 2.

The proportion of the water-miscible organic solvent is preferably 30 percent by mass or greater, more preferably 60 percent by mass or greater, and furthermore preferably 90 percent by mass or greater to the total amount of the organic solvents when a water-immiscible organic solvent is contained in 1.

The particle diameter (size) of the pigment in the pre-pigment dispersion is not particularly limited. The pre-pigment dispersion preferably has a D50 of from 30 to 120 nm and more preferably from 40 to 100 nm to reduce the particle diameter of the pigment-enclosed resin particles. The particle diameter of a pigment can be measured by a zeta-potential particle size measuring system (ELSZ-1000, manufactured by OTSUKA ELECTRONICS Co., LTD.). The content of the pigment in the pre-pigment dispersion is not particularly limited and can be suitably selected to suit to a particular application. The ratio of the pigment to the pigment dispersant in the pre-pigment dispersion is not particularly limited. The ratio is preferably from 4 to 0.2 to 4 to 4 and more preferably from 4 to 0.5 to 4 to 3 to enhance the dispersibility of the pre-pigment dispersion.

It is preferable that the pre-pigment dispersion be purged of coarse particles with a filter or a centrifuge.

The pre-pigment dispersion can be manufactured by optionally dissolving or suspending a pigment dispersant in an organic solvent, and placing a pigment in the organic solvent followed by stirring and dispersing using a known dispersing device. Specific examples of such a dispersing device include, but are not limited to, an anchor wing, dispersing wing, homomixer, ball mill, roll mill, bead mill, sand mill, attritor, pearl mill, DYNO-MILL, high pressure homogenizer, ultrasonic dispersion device, agitator mill, paint shaker, Glen mill, Cobol mill, and jet mill. Of these, a roll mill, bead mill, sand mill, DYNO-MILL, high-pressure homogenizer, and paint shaker are preferably used to enhance dispersion efficiency.

2

In 2, the pre-pigment dispersion obtained in 1 is mixed with resin to obtain a pigment-dispersed resin solution.

The pigment-dispersed resin solution obtained in 2 is obtained by mixing and stirring the pre-pigment dispersion obtained in 1, resin, and other optional substances such as a basic compound, an organic solvent, and an additive. The device for stirring and mixing for use in 2 is not particularly limited. The devices mentioned in 1 can be used. Of these, a high performance stirrer equipped with an anchor wing or dispersing wing is preferably selected to homogeneously stir a sticky solution and efficiently dissolve powdered resin.

The method of adjusting the pigment-dispersed resin solution is not particularly limited. Solid resin can be added to the pre-pigment dispersion obtained in 1 directly or after it is dissolved in an organic solvent.

It is preferable that the particle diameter of the pigment in the pigment-dispersed resin solution be substantially the same as that of the pigment particle in the pre-pigment dispersion obtained in 1. It is more preferable that both be the same in 1 and 2.

The proportion of moisture in the pigment-dispersed resin solution is preferably 20 percent by mass or less, more preferably 10 percent or less, and furthermore preferably 3 percent by mass or less. A proportion of moisture in the pigment-dispersed resin solution greater than 20 percent by mass may degrade the dispersion stability of pigments, causing agglomeration. This agglomeration may increase the particle diameter of the pigment-enclosed resin particles obtained in 3.

The resin is used in 3 to enclose the pigments. It is preferably a self-emulsifying resin. A self-emulsifying resin forms an emulsion when a solution of the self-emulsifying resin and water are mixed and stirred. The self-emulsifying resin preferably has nonionic, anionic, or cationic hydrophilic group. Of these, an anionic hydrophilic group is more preferable.

When the resin is an anionic self-emulsifying resin, it is preferable that the anionic self-emulsifying resin form an emulsion in an aqueous medium and the anionic groups be partially or entirely neutralized with a basic compound to keep the dispersion stability in an aqueous medium.

The mass ratio of the pigment to the resin is preferably from 0.20 to 0.75 and more preferably from 0.30 to 0.60. A ratio of 0.20 or greater is suitable to achieve a good pigment concentration, resulting in excellent printing optical density. A ratio of 0.75 or less allows the resin to cover a large part of a pigment, which reduces the surface roughness of heated and dried coated film, thereby enhancing the optical density. This ratio can be calculated from the preparation ratio or obtained dispersion.

This mass ratio can be calculated from a dispersion by subjecting dried and fixed film of the dispersion to heat analysis using a thermogravimetry-differential thermal analyzer (TG-DTA).

Specifically, a dried and fixed film of a dispersion is heated to and sustained at its thermal decomposition temperature in a nitrogen atmosphere by a TG-DTA. Thereafter, the ratio is calculated from the mass of the decomposed portion as the mass of the resin and the mass of the rest as the mass of the pigment. For a resin not completely decomposed by thermal decomposition in a nitrogen atmosphere because of its high temperature resistance, the loss on heat and the calibration curve of the ratio of the pigment to the resin are used. Specifically, mixtures of pigment and resin are prepared at arbitrary ratio. Each mixture is heated to and kept at a certain temperature to create the calibration curve. The ratio of the pigment to the resin can be calculated based on the ratio of loss obtained by the measurements of an unknown sample.

The mass ratio (R/S) of resin (R) to organic solvent (S) in the pigment-dispersed resin solution is preferably from 1.2 to 3.0 and more preferably from 1.4 to 2.0. A ratio of 1.2 or greater of the resin to the organic solvent accelerates the emulsification speed of the resin in 3, thereby reducing the size of the pigment-enclosed resin particles. A ratio of 3.0 or less prevents the reaction system from becoming sticky. This ameliorates stirring efficiency, thereby preventing production of coarse particles.

3

A liquid dispersion containing pigment-enclosed resin particles is obtained in 3 mentioned above.

The liquid dispersion obtained in 3 is obtained by mixing the solution obtained in 2 with water. The device for stirring and mixing for use in 3 is not particularly limited. The same devices mentioned in 1 can be used. Of these, a high performance stirrer equipped with an anchor wing or dispersing wing is preferably selected to homogeneously stir a sticky solution; however, the enclosure of the pigment-enclosed resin particles produced cannot be maintained or broken under dispersion with excessively high energy.

There is no specific limit to the procedures of mixing the pigment-dispersed resin solution with water. Adding water to the pigment-dispersed resin solution is preferable. The addition rate of water is preferably from 10 to 1,000 parts per minute and more preferably from 30 to 500 parts by mass per minute to 100 parts of resin. An addition rate of from 10 to 1,000 parts per minute prevents pigment agglomeration in the system, thereby minimizing production of coarse pigment-enclosed resin particles.

The amount of water added to resin is preferably from 70 to 700 parts by mass and more preferably from 100 to 500 parts by mass to 100 parts by mass of the resin used in 2 to enhance the dispersion stability of the pigment-enclosed resin particles.

The reaction temperature in 3 is preferably from 20 to 80 degrees C. and more preferably from 30 to 60 degrees C.

4

A liquid dispersion containing pigment-enclosed resin particles is obtained in 4 mentioned above.

The aqueous dispersion obtained in 4 can be obtained by purging the liquid dispersion containing the pigment-enclosed resin particles obtained in 3 of all or part of the organic solvent.

The method of purging the liquid dispersion obtained in 3 of the organic solvent is not particularly limited. Common removing devices can be used. For example, there are a method of heating an organic solvent at its boiling point or higher under a reduced pressure using a rotary evaporator and a method of replacing an organic solvent with water using a ultra-filtering instrument.

Coarse particles in the aqueous dispersion containing the pigment-enclosed resin particles can be optionally filtered by a filter or centrifugal.

### Resin

The resin is not particularly limited. Self-emulsifying resin is preferably used. It includes polyester, polyurethane, and acrylic resin. That self-emulsifying resin preferably has an anionic group.

Specific examples include, but are not limited to, a carboxyl group, carboxylate group, sulfonic acid group, and sulfonate group. Of these, it is preferable to use a carboxylate group or sulfonate group all or part, in particular all of which is neutralized by a substance such as a basic compound.

Specific examples of neutralizing agents usable for neutralizing anionic groups include, but are not limited to, organic amines such as ammonium, triethylamine, pyridine, and morpholine, basic compounds such as alkanolamines such as monoethanol amine, and metal base compounds containing metal such as Na, K, Li, and Ca.

The acid value of the self-emulsifying resin is preferably from 5 to 50 mgKOH/g and more preferably from 10 to 30 mgKOH/g. An acid value of 5 mgKOH or greater stabilizes dispersion, which produces equalized particles in size, thereby enhancing dispersion and dischargeability. An acid value of 50 mgKOH or less optimizes hydrophilicity, thereby enhancing water resistance and stability as particle.

The acid value can be catalog values or calculated based on measurements. The acid value can be measured by placing polyester in a tetrahydrofuran (THF) solution followed by titration with methanol solution of potassium hydroxide at 0.1 M. When a carboxyl group in the resin in an aqueous dispersion is neutralized, an aqueous solution of hydrochloric acid is excessively added to make the system acidic followed by extracting the resin with chloroform. The pigment is removed by centrifugal or filtering followed by heating or drying under a reduced pressure to obtain dried and fixed matter of the resin. The thus-obtained resin is dissolved in THF followed by titration using methanol solution of potassium hydroxide at 0.1 M.

Polyester is described below in detail as one of the self emulsifying resin.

### Polyester

Polyester is obtained by polycondensing a polyhydric alcohol with a polycarboxylic acid and/or its derivative such as a polyvalent-carboxylic acid, polycarboxylic anhydride, and polycarboxylic acid ester. It partially or entirely includes an aromatic unit. The aromatic polyester contains a polyhydric alcohol and a polycarboxylic acid and/or its derivative such as a polyvalent-carboxylic acid, polycarboxylic anhydride, and polycarboxylic acid ester as its components.

### Polyhydric Alcohol Component

Specific examples of the polyhydric alcohol component include, but are not limited to, diol such as alkylene glycols having 2 to 36 carbon atoms such as ethylene glycol, 1,2-propylene glycol, 1,3-propylene glycol, 1,4,-butylene glycol, 1,6-hexane diol, and trimethylol propane, alkylene ether glycols having 4 to 36 carbon atoms such as diethylene glycol, triethylene glycol, dipropylene glycol, polyethylene glycol, polypropylene glycol, and polybutylene glycol, alicyclic diols having 6 to 36 carbon atoms such as 1,4-cyclohexane dimethanol and hydrogenated bisphenol A, adducts (number of adduct mols of from 1 to 30 mols) of alkylene oxide having 2 to 4 carbon atoms of the alicyclic diol mentioned above such as ethylene oxide (EO), propylene oxide (PO), and butylene oxide (BO), and adducts (number of adduct mols of from 2 to 30 mols) of bisphenols such as bisphenol A, bisphenol F, and bisphenol S with alkylene oxide having 2 to 4 carbon atoms such as EO, PO, and BO.

In addition to the diols mentioned above, tri- or higher (tri- to octic or higher) alcohol components can be contained.

Specific examples include, but are not limited to, tri- to octic or higher aliphatic polyhydric alcohols having 3 to 36 carbon atoms such as alkane polyols and inner or inter molecular dehydrated matter such as glycerin, triethylol ethane, trimethyl propane, pentaerythritol, sorbitol, sorbitan, polyglycerin, and dipenta erythritol, sugar and its derivative such as sugar and methyl glucoside, adducts (number of adduct mols of from 1 to 30 mols) of aliphatic polyols with alkylene oxide having 2 to 4 carbon atoms such as EO, PO, and BO, adducts (number of adduct mols of from 2 to 30 mols) of trisphenol such as trisphenol PA with alkylene oxide having 2 to 4 carbon atoms such as EO, PO, and BO, and adducts (number of adduct mols of from 2 to 30 mols) of novolac resin such as phenol novolac and crezol novolac with an average degree of polymerization of from 3 to 60 with alkylene oxide having 2 to 4 carbon atoms such as EO, PO, and BO. These can be used alone or in combination.

### Polycarboxylic Acid Component

Specific examples of the polyvalent carboxylic acid component include, but are not limited to, dicarboxylic acids such as alkane dicarboxylic acid having 4 to 36 carbon atoms such as succinic acid, adipic acid, and sebacic acid), alkenyl succinic acid such as dodecenyl succinic acid, alicyclic dicarboxylic acid having 4 to 36 carbon atoms such as dimer acid (dimer linolic acid), alkene dicarboxylic acid having 4 to 36 carbon atoms such as maleic acid, fumaric acid, citraconic acid, and mesaconic acid, and aromatic dicarboxylic acid having 8 to 36 carbon atoms such as phthalic acid, isophthalic acid, terephthalic acid, their derivatives, and naphthalene dicarboxylic acid. Of these, alkane dicarboxylic acids having 4 to 20 carbon atoms and aromatic dicarboxylic acids having 8 to 20 carbon atoms are preferable. The polycarboxylic acid components also include anhydrides of the mentioned above or lower alkyl (with 1 to 4 carbon atoms) ester such as methyl ester, ethyl ester, and isopropyl ester. These can be used alone or in combination.

Ring-opening polymers such as polylactic acid or polycarbonate diol can be also used.

One way of isolating the polyester mentioned above is to; dry and fixate an aqueous dispersion containing pigment-enclosed resin particles by heating and drying; put the obtained dried matter in a THF solution to dissolve polyester; then, remove the pigment contained by centrifugal and filtering; and remove THF to isolate polyester. It is allowed to use a recycle gas permeation chromatography (GPC).

The molecular weight of the polyester has no specific limit can be suitably selected to suit to a particular application. The mass average molecular weight (Mw) is preferably from 2,000 to 15,000 and more preferably from 4,000 to 12,000 as measured by GPC.

There is no specific limitation to the glass transition temperature (TG) of the polyester and it can be suitably selected to suit to a particular application. The Tg is preferably from 30 to 100 degrees C. and more preferably from 50 to 80 degrees C.

There is no specific limitation to the softening temperature of the polyester. It is preferably from 60 to 180 degrees C. and more preferably from 80 to 150 degrees C.

The molecule structure of the polyester can be confirmed by nuclear magnetic resonance (NMR) measurement of a solution or solid. GC/MS, LC/MS, infrared (IR) absorption measurements can be also used.

The polyester mentioned above can be manufactured by any of known methods including the following method.

The polyester can be manufactured by polycondensation of the polyhydric alcohol mentioned above and the polycarboxylic acid under the absence or presence of an organic solvent.

The acid value of the polyester can be adjusted by any method. It is possible to increase the acid value by reacting the obtained polyester with a polycarboxylic acid and an anhydride of carboxylic acid.

### Pigment

Inorganic pigments can be used as the pigment mentioned above.

Specific examples include, but are not limited to, titanium oxide, iron oxide, calcium carbonate, barium sulfate, aluminum hydroxide, barium yellow, cadmium red, and chromium yellow. Carbon black (C.I.Pigment Black 7) manufactured by a known method such as furnace black, lamp black, acetylene black, and channel black, and metals such as copper and iron (C.I.Pigment Black 11) can be used. Such carbon black preferably has a primary particle diameter in number of from 15 to 100 nm. Coloring property is improved in this region.

The carbon black mentioned above is measured by a TEM followed by processing the image obtained with an image analysis software (ImageJ, created by National Institutes of Health). Twenty primary particles are taken at random and the particle diameter thereof is measured by image analysis to calculate the average. Not the minor diameter but the major diameter is used for the calculation.

The absorption of the carbon black mentioned above by dibutyl terephtalate (DPB) is preferably from 30 to 150 mL/100 g. Pigment dispersibility in an organic solvent is improved in this range. The DPB absorption of carbon black is measured according to JIS K6217 format.

In addition, self-dispersible pigments can be allowed. They are stably dispersed by introducing a functional group to the surface of a pigment directly or via another atom group. As the pigment which is not stably dispersed yet, variety of conventional pigments specified in, for example, WO-2009/014242, can be used.

### Pigment Dispersant

It is preferable to add a pigment dispersant to the pre-pigment dispersion to enhance the dispersibility of a pigment. The pigment dispersant is not particularly limited and can be suitably selected to suit to a particular application. It includes a surfactant and a polymer dispersant.

Specific examples of the pigment dispersant include, but are not limited to, (meth)acrylic resins, styrene-(meth)acrylic resins, carboxylic acid esters including a hydroxyl group, salts of long chain polyamino amides and polar acid esters, unsaturated acid esters, copolymers, modified polyurethane, modified polyacrylate, polyether ester anionic active agents, salts of condensation products of naphthalene sulfonic acid and formalin, salts of condensation products of aromatic sulfonic acid and formalin, polyoxy ethylene alkyl phosphate, polyoxyethyelene nonyl phenyl ether, and stearyl amine acetate.

The pigment dispersant mentioned above is not particularly limited regarding hydrophilicity and hydrophobicity. It can be suitably selected to suit to a particular application. Pigments are readily enclosed in resin with a hydrophobic dispersant, which is preferable to enhance the optical density. Whether the pigment dispersant mentioned above is hydrophobic or hydrophilic is determined by water-solubility. If water-soluble, it is hydrophilic and if not, it is hydrophobic.

Specific examples of the pigment dispersant include, but are not limited to, JONCRYL® (manufactured by Johnson Polymer), Anti-Terra-U (manufactured by BYK Chemie), Disperbyk (manufactured by Byk Chemie), Efka (manufactured by Efka CHEMICALS), FLOWLEN (manufactured by Kyoeisha Chemical Co., Ltd.), DISPARLON (manufactured by Kusumoto Chemicals, Ltd.), AJISPER (manufactured by Ajinomoto Fine-Techno Co., Inc.), DEMOL, HOMOGENOL, and EMULGEN (all manufactured by Kao Corporation), Solsperse (manufactured by The Lubrizol Corporation), and NIKKOL (manufactured by Nikko Chemicals Co., Ltd.).

### Ink

Organic solvents, water, coloring materials, resin, and additives for use in the ink are described below.

### Organic Solvent

There is no specific limitation to the organic solvent for use in the present disclosure. For example, a water-soluble organic solvent can be used. It includes, but is not limited to, polyhydric alcohols, ethers such as polyhydric alcohol alkylethers and polyhydric alcohol arylethers, nitrogen-containing heterocyclic compounds, amides, amines, and sulfur-containing compounds.

Specific examples of the water-soluble organic solvent include, but are not limited to: polyhydric alcohols such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butane diol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butane triol, 1,2,3-butanetriol, 2,2,4-trimethyl-1,3-pentanediol, and petriol; polyol alkyl ethers such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether; polyol aryl ethers such as ethylene glycol monophenyl ether and ethylene glycol monobenzyl ether; nitrogen-containing heterocyclic compounds such as 2-pyrrolidone, N-methyl-2-pyrrolidone, N-hydroxyethyl-2-pyrrolidone, 1,3-dimethyl-2-imidazolidinone, ε-caprolactam, and γ-butyrolactone; amides such as formamide, N-methylformamide, N,N-dimethylformamide, 3-methoxy-N,N-dimethyl propioneamide, and 3-buthoxy-N,N-dimethyl propioneamide; amines such as monoethanolamine, diethanolamine, and triethylamine; sulfur-containing compounds such as dimethyl sulfoxide, sulfolane, and thiodiethanol; propylene carbonate, and ethylene carbonate

It is preferable to use an organic solvent having a boiling point of 250 or lower degrees C., which serves as a humectant and imparts a good drying property at the same time.

Polyol compounds having eight or more carbon atoms and glycol ether compounds are also suitable.

Specific examples of the polyol compounds having eight or more carbon atoms include, but are not limited to, 2-ethyl-1,3-hexanediol and 2,2,4-trimethyl-1,3-pentanediol.

Specific examples of the glycolether compounds include, but are not limited to, polyhydric alcohol alkylethers such as ethylene glycol monoethylether, ethylene glycol monobutylether, diethylene glycol monomethylether, diethylene glycol monoethylether, diethylene glycol monobutylether, tetraethylene glycol monomethylether, and propylene glycol monoethylether and polyhydric alcohol arylethers such as ethylene glycol monophenylether and ethylene glycol monobenzylether.

A polyol compound having eight or more carbon atoms and a glycol ether compound enhance permeability of ink for paper used as a recording medium.

The proportion of the organic solvent in ink has no particular limit and can be suitably selected to suit to a particular application.

In terms of drying and discharging reliability of the ink, the proportion is preferably from 10 to 60 percent by mass and more preferably from 20 to 60 percent by mass.

### Water

The proportion of water in the ink is not particularly limited and can be suitably selected to suit to a particular application. In terms of drying and discharging reliability of the ink, the proportion is preferably from 10 to 90 percent by mass and more preferably from 20 to 60 percent by mass.

The particle diameter of the solid portion in the ink has no particular limit and can be suitably selected to suit to a particular application. For example, the maximum frequency in the maximum number conversion is preferably from 20 to 1,000 nm and more preferably from 20 to 150 nm to ameliorate the discharging stability and image quality such as optical density. The solid content includes resin particles and particles of pigment. The particle diameter can be measured by using a particle size analyzer (Nanotrac Wave-UT151, manufactured by MicrotracBEL Corp).

### Additive

The ink may further optionally include additives such as a surfactant, defoaming agent, preservative and fungicide, corrosion inhibitor, and pH regulator.

### Surfactant

Examples of the surfactant include, but are not limited to, silicone-based surfactants, fluorochemical surfactants, amphoteric surfactants, nonionic surfactants, and anionic surfactants.

The silicone-based surfactant has no specific limit and can be suitably selected to suit to a particular application. Of these, surfactants not decomposable in a high pH environment are preferable. Examples of the silicone-based surfactants include, but are not limited to, side chain modified polydimethyl siloxane, both terminal-modified polydimethyl siloxane, one-terminal-modified polydimethyl siloxane, and side-chain-both-terminal-modified polydimethyl siloxane. In particular, silicone-based surfactants having a polyoxyethylene group or a polyoxyethylene polyoxypropylene group as a modification group are particularly preferable because such an aqueous surfactant demonstrates good properties. It is possible to use a polyether-modified silicone-based surfactant as the silicone-based surfactant. A specific example is a compound in which a polyalkylene oxide structure is introduced into the side chain of the Si site of dimethyl silooxane.

Specific examples of the fluorochemical surfactant include, but are not limited to, perfluoroalkyl sulfonic acid compounds, perfluoroalkyl carboxylic acid compounds, ester compounds of perfluoroalkyl phosphoric acid, adducts of perfluoroalkyl ethylene oxide, and polyoxyalkylene ether polymer compounds having a perfluoroalkyl ether group in its side chain. These are particularly preferable because the fluorochemical surfactant does not readily produce foams.

Specific examples of the perfluoroalkyl sulfonic acid compounds include, but are not limited to, perfluoroalkyl sulfonic acid and salts of perfluoroalkyl sulfonic acid.

Specific examples of the perfluoroalkyl carbonic acid compounds include, but are not limited to, perfluoroalkyl carbonic acid and salts of perfluoroalkyl carbonic acid.

Specific examples of the polyoxyalkylene ether polymer compounds having a perfluoroalkyl ether group in its side chain include, but are not limited to, sulfuric acid ester salts of polyoxyalkylene ether polymer having a perfluoroalkyl ether group in its side chain, and salts of polyoxyalkylene ether polymers having a perfluoroalkyl ether group in its side chain. Counter ions of salts in these fluorochemical surfactants are, for example, Li, Na, K, NH₄, NH₃CH₂CH₂OH, NH₂(CH₂CH₂OH)₂, and NH(CH₂CH₂OH)₃.

Specific examples of the amphoteric surfactants include, but are not limited to, lauryl aminopropionic acid salts, lauryl dimethyl betaine, stearyl dimethyl betaine, and lauryl dihydroxyethyl betaine.

Specific examples of the nonionic surfactants include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides.

Specific examples of the anionic surfactants include, but are not limited to, polyoxyethylene alkyl ether acetates, dodecyl benzene sulfonates, laurates, and polyoxyethylene alkyl ether sulfates.

These can be used alone or in combination.

The silicone-based surfactant has no particular limit and can be suitably selected to suit to a particular application.

Specific examples include, but are not limited to, side-chain-modified polydimethyl siloxane, both terminal-modified polydimethyl siloxane, one-terminal-modified polydimethyl siloxane, and side chain both-terminal-modified polydimethyl siloxane. Of these, a polyether-modified silicone-based surfactant having a polyoxyethylene group or a polyoxyethylene polyoxypropylene group is particularly preferable because such a surfactant demonstrates good property as the aqueous surfactant.

Such surfactants can be synthesized or procured. Products can be procured from BYK-Chemie GmbH, Shin-Etsu Silicone Co., Ltd., Dow Coming Toray Co., Ltd., NIHON EMULSION Co., Ltd., Kyoeisha Chemical Co., Ltd., and others.

The polyether-modified silicon-based surfactant has no particular limit and can be suitably selected to suit to a particular application. For example, a compound is usable in which the polyalkylene oxide structure represented by the following Chemical Formula S-1 is introduced into the side chain of the Si site of dimethyl polysiloxane.

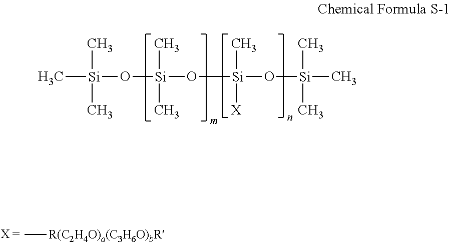

In Chemical Formula S-1, “m”, “n”, “a”, and “b” each, respectively independently represent integers, R represents an alkylene group, and R′ represents an alkyl group.

Specific examples of the polyether-modified silicone-based surfactant include, but are not limited to, KF-618, KF-642, and KF-643 (all manufactured by Shin-Etsu Chemical Co., Ltd.), EMALEX-SS-5602 and SS-1906EX (both manufactured by NIHON EMULSION Co., Ltd.), FZ-2105, FZ-2118, FZ-2154, FZ-2161, FZ-2162, FZ-2163, and FZ-2164 (all manufactured by Dow Corning Toray Co., Ltd.), BYK-33 and BYK-387 (both manufactured by BYK Chemie GmbH), and TSF4440, TSF4452, and TSF4453 (all manufactured by Momentive Performance Materials Inc.).

A fluorochemical surfactant in which the number of carbon atoms replaced with fluorine atoms is 2 to 16 is preferable and, 4 to 16, more preferable.

Specific examples of the fluorochemical surfactant include, but are not limited to, perfluoroalkyl phosphoric acid ester compounds, adducts of perfluoroalkyl with ethylene oxide, and polyoxyalkylene ether polymer compounds having a perfluoroalkyl ether group in its side chain. Of these, polyoxyalkylene ether polymer compounds having a perfluoroalkyl ether group in its side chain are preferable because these do not easily foam and the fluorochemical surfactant represented by the following Chemical Formula F-1 or Chemical Formula F-2 is preferable.

CF₃CF₂(CF₂CF₂)ₘ—CH₂CH₂O(CH₂CH₂O)ₙH Chemical Formula F-1

In the compound represented by Chemical Formula F-1, “m” is preferably 0 or an integer of from 1 to 10 and “n” is preferably 0 or an integer of from 1 to 40.

CₙF₂ₙ₊₁—CH₂CH(OH)CH₂—O—(CH₂CH₂O)ₙ—Y Chemical Formula F-2

In the compound represented by the Chemical Formula F-2, Y represents H or CₘF₂ₘ₊₁, where n represents an integer of from 1 to 6, or CH₂CH(OH)CH₂—CₘF₂ₘ₊₁, where m represents an integer of from 4 to 6, or CₚH₂ₚ₊₁, where p is an integer of from 1 to 19. n represents an integer of from 1 to 6. a represents an integer of from 4 to 14.

The fluorochemical surfactant is commercially available.

Specific examples include, but are not limited to, SURFLON S-111, S-112, S-113, S-121, S-131, S-132, S-141, and S-145 (all manufactured by ASAHI GLASS CO., LTD.); FLUORAD FC-93, FC-95, FC-98, FC-129, FC-135, FC-170C, FC-430, and FC-431 (all manufactured by SUMITOMO 3M); MEGAFACE F-470, F-1405, and F-474 (all manufactured by DIC CORPORATION); ZONYL TBS, FSP, FSA, FSN-100, FSN, FSO-100, FSO, FS-300, UR, and Capstone™ FS-30, FS-31, FS-3100, FS-34, and FS-35 (all manufactured by The Chemours Company); FT-110, FT-250, FT-251, FT-400S, FT-150, and FT-400SW (all manufactured by NEOS COMPANY LIMITED); POLYFOX PF-136A, PF-156A, PF-151N, PF-154, and PF-159 (manufactured by OMNOVA SOLUTIONS INC.); and UNIDYNE™ DSN-403N (manufactured by DAIKIN INDUSTRIES, Ltd.). Of these, in terms of improvement on print quality, in particular coloring property and permeability, wettability, and uniform dying property on paper, FS-3100, FS-34, and FS-300 of The Chemours Company, FT-110, FT-250, FT-251, FT-400S, FT-150, and FT-400SW of NEOS COMPANY LIMITED, POLYFOX PF-151N of OMNOVA SOLUTIONS INC., and UNIDYNE™ DSN-403N (manufactured by DAIKIN INDUSTRIES, Ltd.) are particularly preferable.

The proportion of the surfactant in the ink is not particularly limited and can be suitably selected to suit to a particular application. For example, the proportion is preferably from 0.001 to 5 percent by mass and more preferably from 0.05 to 5 percent by mass to achieve excellent wettability and discharging stability and improve image quality.

### Defoaming Agent

The defoaming agent has no particular limit. Examples include, but are not limited to silicon-based defoaming agents, polyether-based defoaming agents, and aliphatic acid ester-based defoaming agents. These can be used alone or in combination. Of these, silicone-based defoaming agents are preferable to achieve the effect of foam breaking.

### Preservatives and Fungicides

The preservatives and fungicides are not particularly limited. A specific example is 1,2-benzisothiazoline-3-one.

### Corrosion Inhibitor

The corrosion inhibitor has no particular limitation.

Specific examples include, but are not limited to, acid sulfites and sodium thiosulfates.

### pH Regulator

The pH regulator has no particular limit as long as it can control pH to be not lower than 7. Specific examples include, but are not limited to, amines such as diethanol amine and triethanol amine.

Properties of the ink are not particularly limited and can be suitably selected to suit to a particular application; viscosity, surface tension, and pH are preferable in the following ranges.

The ink preferably has a viscosity of from 5 to 30 mPa·s and more preferably from 5 to 25 mPa·s at 25 degrees C. to enhance the print density and text quality and achieve a good dischargeability. Viscosity can be measured by equipment such as a rotatory viscometer (RE-80L, manufactured by TOKI SANGYO CO., LTD.). The measuring conditions are as follows:
Standard cone rotor (1° 34′×R24)
Sample liquid amount: 1.2 mL
Rate of rotations: 50 rotations per minute (rpm)
25 degrees C.
Measuring time: three minutes.

The surface tension of the ink is preferably 35 mN/m or less and more preferably 32 mN/m or less at 25 degrees C. because the ink suitably levels on a recording medium and the ink dries in a shorter time.

pH of the ink is preferably from 7 to 12 and more preferably from 8 to 11 to prevent corrosion of metal material in contact with liquid.

### Pre-Processing Fluid

The pre-processing fluid includes a flocculant, an organic solvent, water, and optional materials such as a surfactant, a defoaming agent, a pH regulator, a preservatives and fungicides, and a corrosion inhibitor.

The organic solvent, the surfactant, the defoaming agent, the pH regulator, the preservatives and fungicides, and the corrosion inhibitor can be the same material as those for use in ink. Other material for use in known processing fluid can be used.

The type of the flocculant is not particularly limited. For example, water-soluble cationic polymers, acids, and multi-valent metal salts are suitable.

### Post-Processing Fluid

The post-processing fluid has no particular limit. It is preferable that the post-processing fluid can form a transparent layer. Material such as organic solvents, water, resins, surfactants, defoaming agents, pH regulators, preservatives and fungicides, corrosion inhibitors, etc. is suitably selected based on a necessity basis and mixed to obtain the post-processing fluid. The post-processing fluid can be applied to the entire recording area formed on a recording medium or only the area on which an ink image is formed.

### Recording Medium

The recording medium is not particularly limited. Materials such as plain paper, gloss paper, special paper, and cloth are usable. Also, good images can be formed on a non-permeating substrate.

The non-permeating substrate has a surface with low moisture permeability and absorbency. It includes a material having a number of hollow spaces inside that are not open to the outside. To be more quantitative, the substrate has a water-absorbency of 10 or less mL/m² from the start of the contact until 30 msec^{1/2} later according to Bristow's method.

For example, plastic films such as vinyl chloride resin film, polyethylene terephthalate (PET) film, polypropylene film, polyethylene film, and polycarbonate film are suitably used as the non-permeable substrate.

The recording media are not limited to typical recording media and suitably include building materials such as wall paper, floor material, and tiles, cloth for apparel such as T-shirts, textile, and leather. The configuration of the paths through which the recording medium is conveyed can be changed to use materials such as ceramics, glass, and metal.

### Recorded Matter

Ink recorded matter includes a recording medium and an image formed on the recording medium with the ink contained in the ink set of the present disclosure.

The recorded matter is obtained by an inkjet recording device executing an inkjet recording method.

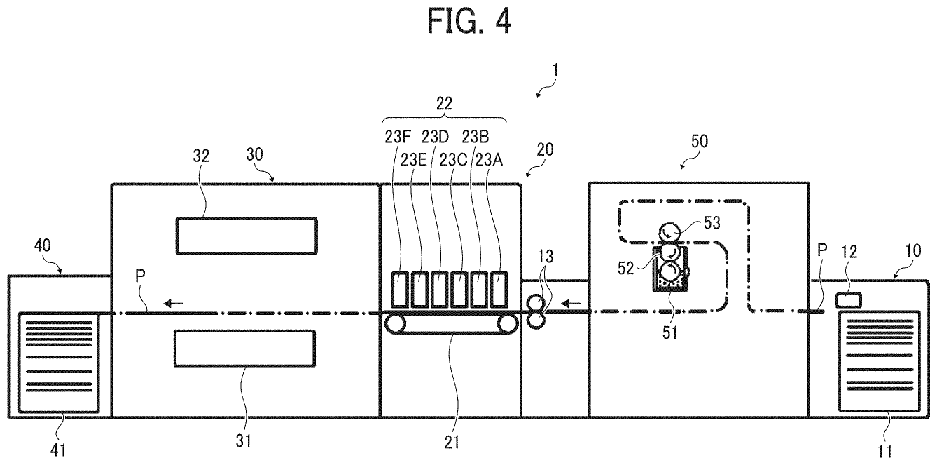

FIG. 4 is a diagram illustrating an embodiment of a printer using the ink of the present disclosure.

A printer 1 includes a feeding unit 10, a pre-processing unit 50, a printing unit 20, a drying unit 30, and an ejecting unit 40. The printer 1 applies processing fluid at the pre-processing unit 50 to a sheet P conveyed from the feeding unit 10. It applies liquid to the sheet P at the printing unit 20 for determined printing. Thereafter, the liquid on the sheet P is dried at the drying unit 30. The sheet P is then ejected to the ejecting unit 40.

The feeding unit 10 includes a feeding tray 11 carrying multiple sheets P, a feeding device 12 that separates the sheets P one sheet by one sheet and sends out from the feeding tray 11, and a pair of registration rollers 13 that feeds the sheets P to the printing unit 20.

The feeding device 12 may include any feeding device such as a device using a roller or a device utilizing air suction. After the front end of the sheet P fed from the feeding tray 11 by the feeding device 12 reaches the registration rollers 13, it is sent out to the printing unit 20 by the operation of the registration rollers 13 at a certain timing.

The pre-processing unit 50 includes a processing fluid container 51 containing processing fluid that reacts with the liquid to minimize bleeding and a pre-application processing rotation body as a processing liquid application device that applies the processing fluid to the sheet P. The pre-application processing rotation body includes a drawing roller for drawing the processing fluid, an application roller 52 that receives the processing fluid attached to the drawing roller and applies the processing fluid to the surface of the sheet P, and a roller 53 that pinches the sheet P by pressing it against the application roller 52.

After the processing fluid is applied to the rear side of the sheet P by the application roller 52, the sheet P is reversed and fed into the registration rollers 13 constituting the feeding unit 10.

The printing unit 20 includes a sheet conveyor 21 that conveys the sheet P. The sheet conveyor 21 includes a belt that bears and conveys the sheet P and a suction device producing suction power at the surface of the belt.

The printing unit 20 includes a liquid discharging unit 22 that discharges and applies the liquid to the surface of the sheet P borne and conveyed by the sheet conveyor 21 to attach the processing fluid to the surface.

The liquid discharging unit 22 includes a discharging unit 23 (23A to 23F) as a liquid application device. For example, the discharging unit 23A, the discharging unit 23B, the discharging 23C, the discharging unit 23D, and the discharging unit E respectively discharge liquid of cyan (C), liquid of magenta (M), liquid of yellow (Y), liquid of black (K), and liquid of white (W). The discharging unit 23F is used to discharge either one of YMCK or a special liquid having a color such as white, silver, and gold. The discharging units 23A to 23E are provided on a necessity basis. A discharging unit that discharges processing fluid such as surface coating liquid can be added.

One embodiment of the discharging unit 23 is a full line head constituted of multiple liquid discharging heads (hereinafter simply referred to as head), each having nozzle lines including multiple nozzles respectively.

Each of the discharging units 23 of the liquid discharging unit 22 is controlled by drive signals in accordance with the printing information. The discharging units 23 discharge each color liquid when the sheet P borne on the drum passes through the opposition region of the liquid discharging unit 22. Images corresponding to the printing information are printed on the sheet P.

The sheet P to which the liquid is applied by the liquid discharging unit 22 is conveyed to a suction conveyance mechanism 31 of the drying unit 30.

The drying unit 30 includes the suction conveyance mechanism 31 as a conveying device that conveys the sheet P while it is suctioned and a drying mechanism 32 that dries the liquid on the sheet P conveyed by the suction conveyance mechanism 31.

The sheet P where the liquid is applied at the printing unit 20 is dried at the drying mechanism 32 while the sheet P is conveyed by the suction conveyance mechanism 31. Thereafter, the sheet P is sent to the ejecting unit 40.

The ejecting unit 40 includes an ejection tray 41 at which the sheets P is stacked. The sheet P conveyed from the drying unit 30 is sequentially stacked on the ejection tray 41 and stored.

Although the pre-processing unit 50 is configured to apply the processing fluid to one side of the sheet P in this embodiment, the configuration is not limited thereto. The pre-processing unit 50 may include another processing fluid container, which can be deposited downstream of the processing fluid container 51 in the conveyance direction of the sheet P to apply the processing fluid to the other side of the sheet P. Alternatively, the pre-processing unit 50 is configured to reverse the sheet P that has once passed through the processing fluid container 51 and then apply the processing fluid to the other side of the sheet P when it passes through the processing fluid container 51 again.

Notably, the ink is applicable not only to the inkjet recording but can be widely applied in other methods.

Specific examples of such methods other than the inkjet recording include, but are not limited to, blade coating methods, gravure coating methods, bar coating methods, roll coating methods, dip coating methods, curtain coating methods, slide coating methods, die coating methods, and spray coating methods.

The usage of the ink of the present disclosure is not particularly limited and can be suitably selected to suit to a particular application. For example, the ink can be used for printed matter, a paint, a coating material, and foundation. The ink can be used to produce two-dimensional text and images and furthermore used as a material for solid fabrication for manufacturing a solid fabrication object (or solid freeform fabrication object).

The solid fabrication apparatus to fabricate a solid fabrication object can be any known device with no particular limit. For example, the apparatus includes a container, supplying device, discharging device, drier of ink, and others. The solid fabrication object includes an object manufactured by repetitively coating ink. In addition, the solid fabrication object includes a mold-processed product manufactured by processing a structure having a substrate such as a recording medium to which the ink is applied. The mold-processed product is manufactured from recorded matter or a structure having a form such as a sheet-like form, and film-like form. by, processing such as heating drawing or punching. The molded processed product is suitably used for articles which are molded after surface-decorating. Examples are gauges or operation panels of vehicles, office machines, electric and electronic devices, cameras, etc.

The terms of image forming, recording, and printing in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present disclosure is described in detail with reference to Examples but is not limited thereto. In the following description, “parts” means “parts by mass” unless otherwise specified, and “percent” means “percent by mass” unless otherwise specified.

Synthesis Examples of materials constituting ink and Manufacturing Examples of pre-pigment dispersions, aqueous dispersions, and inks are described below. The method of evaluating the properties of the aqueous dispersion and ink ie described later.

### Manufacturing Example

### Self-Emulsifying Resin: Synthesis Example of Polyester

### Polyester α

A total of 275 parts of an adduct of bisphenol A with 2 mols of ethylene oxide (4,4′-isopropylidene bis(2-phenoxy ethanol), manufactured by Fuji Film Wako Chemicals) and 79 parts of an adduct of bisphenol A with 2 mols of propylene oxide (BA-P2 glycol, manufactured by Nippon Nyukazai Co., Ltd.) as diols, 140 parts of dimethyl isophthalate and 26 parts of adipic acid as dicarboxylic acids were mixed in a four-necked flask (500 mL) equipped with a nitrogen introducing tube, a dehydration tube, a stirrer, and a thermocouple. Subsequent to sufficient replacement with nitrogen gas in the flask, 300 ppm (based on the monomer) of titanium tetraisopropoxide was added. The temperature was thereafter raised to 200 degrees C. in about four hours in a nitrogen atmosphere. The temperature was then raised to 230 degrees C. over two hours to allow the reaction until no effluent was produced any more. Thereafter, the reaction was allowed to continue under a reduced pressure of from 5 to 30 mm Hg for one hour to obtain polyester.

A total of 160 parts of the polyester thus obtained was melted at 180 degrees C. in a nitrogen atmosphere followed by an addition of 6 parts of trimellitic anhydride. The mixture was stirred for 40 minutes to adjust the acid value of the resin. The obtained resin, polyester a had an acid value (AV) of 20 mgKOH/g, a glass transition temperature (Tg) of 51 degrees C., and a mass average molecular weight (Mw) of 5,100.

### Polyester β

First, 146 parts of propylene glycol, 54.6 parts of an adduct of bisphenol A with 2 mols of ethylene oxide (4,4′-isopropylidene bis(2-phenoxy ethanol), manufactured by Fuji Film Wako Chemicals), and 250.7 parts of an adduct of bisphenol A with 2 mols of propylene oxide (BA-P2 glycol, manufactured by Nippon Nyukazai Co., Ltd.) as diols, 6.4 parts of trimethylol propane as a triol, and 193.7 parts of dimethyl terephthalate as a dicarboxylic acid were mixed in a four-necked flask (500 mL) equipped with a nitrogen introducing tube, a dehydration tube, a stirrer, and a thermocouple. Subsequent to sufficient replacement with nitrogen gas in the flask, 300 ppm (based on the monomer) of titanium tetraisopropoxide was added. The temperature was thereafter raised to 200 degrees C. in about four hours in a nitrogen atmosphere. The temperature was then raised to 230 degrees C. over two hours to allow the reaction until no effluent was produced any more. Thereafter, the reaction was allowed to continue under a reduced pressure of from 5 to 30 mm Hg for four hours to obtain polyester.

The thus-obtained resin had an acid value (AV) of 0.4 mg KOH/g, a glass transition temperature (Tg) of 80 degrees C., and a weight average molecular weight (Mw) of 25,000.

A total of 150 parts of the polyester thus obtained was melted at 180 degrees C. in a nitrogen atmosphere followed by an addition of 4.2 parts of trimellitic anhydride. The mixture was stirred for 40 minutes to adjust the acid value of the resin. The obtained resin, polyester α had an acid value (AV) of 20 mgKOH/g, a glass transition temperature (Tg) of 81 degrees C., and a mass average molecular weight (Mw) of 26,000.

### Preparation of Pre-Pigment Dispersion

### Pre-Pigment Dispersion A

The following recipe was mixed and placed in a glass screw tube bin (200 ml). Thereafter, 170 parts of zirconia balls having a diameter of 2.0 mm (YTZ ball, manufactured by NIKKATO CORPORATION) was added. The bin was fixed in a shaker (Vibrax VXR basic, manufactured by IKA Company) for dispersing at 1,000 rpm for 24 hours. Thereafter, the obtained liquid dispersion and media were filtered followed by filtering with a PTFE membrane filter having an average pore diameter of 5.0 μm to prepare a pre-pigment dispersion A. The D50 of this pre-pigment dispersion was 110 nm by ELSZ-1000.
Carbon black (SBX45, primary particle diameter of 22 nm, DPB absorption amount of 55 mL/100 g, manufactured by ASAHI CARBON CO., LTD.): 25.3 parts
Pigment dispersant (AJISPER PB821, hydrophobic, Ajinomoto Fine-Techno Co., Inc.): 6.3 parts
Tetrahydrofuran: 68.4 parts

### Pre-Pigment Dispersion B

The following recipe was mixed and placed in a glass screw tube bin (200 ml). Thereafter, 170 parts of zirconia balls having a diameter of 2.0 mm (YTZ ball, manufactured by NIKKATO CORPORATION) was added. The bin was fixed in a shaker (Vibrax VXR basic, manufactured by IKA Company) for dispersing at 1,000 rpm for 24 hours. Thereafter, the obtained liquid dispersion and media were filtered followed by filtering with a PTFE membrane filter having an average pore diameter of 5.0 μm to prepare a pre-pigment dispersion B. The D50 of this pre-pigment dispersion was 110 nm by ELSZ-1000.
Carbon black (SBX45, primary particle diameter of 22 nm, DPB absorption amount of 55 mL/100 g, manufactured by ASAHI CARBON CO., LTD.): 31.6 parts
Pigment dispersant (AJISPER PB821, hydrophobic, Ajinomoto Fine-Techno Co., Inc.): 7.9 parts
Tetrahydrofuran: 48.4 parts
Methylethyl ketone: 12.1 parts

### Pre-Pigment Dispersion C

The following recipe was mixed and placed in a glass screw tube bin (200 ml). Thereafter, 170 parts of zirconia balls having a diameter of 2.0 mm (YTZ ball, manufactured by NIKKATO CORPORATION) was added. The bin was fixed in a shaker (Vibrax VXR basic, manufactured by IKA Company) for dispersing at 1,000 rpm for 24 hours. Thereafter, the obtained liquid dispersion and media were filtered followed by filtering with a PTFE membrane filter having an average pore diameter of 5.0 μm to prepare a pre-pigment dispersion C. The D50 of this pre-pigment dispersion was 110 nm by ELSZ-1000.
Carbon black (SBX45, primary particle diameter of 22 nm, DPB absorption amount of 55 mL/100 g, manufactured by ASAHI CARBON CO., LTD.): 31.6 parts
Pigment dispersant (AJISPER PB821, hydrophobic, Ajinomoto Fine-Techno Co., Inc.): 7.9 parts
Tetrahydrofuran: 30.25 parts
Methylethyl ketone: 30.25 parts

### Pre-Pigment Dispersion D

The following recipe was mixed and placed in a glass screw tube bin (200 ml). Thereafter, 170 parts of zirconia balls having a diameter of 2.0 mm (YTZ ball, manufactured by NIKKATO CORPORATION) was added. The bin was fixed in a shaker (Vibrax VXR basic, manufactured by IKA Company) for dispersing at 1,000 rpm for 24 hours. Thereafter, the obtained liquid dispersion and media were filtered followed by filtering with a PTFE membrane filter having an average pore diameter of 5.0 μm to prepare a pre-pigment dispersion D. The D50 of this pre-pigment dispersion was 110 nm by ELSZ-1000.
Carbon black (SBX45, primary particle diameter of 22 nm, DPB absorption amount of 55 mL/100 g, manufactured by ASAHI CARBON CO., LTD.): 31.6 parts
Pigment dispersant (AJISPER PB821, hydrophobic, Ajinomoto Fine-Techno Co., Inc.): 7.9 parts
N-methyl pyrrolidone: 60.5 parts

### Pre-Pigment Dispersion E

The following recipe was mixed and placed in a glass screw tube bin (200 ml). Thereafter, 170 parts of zirconia balls having a diameter of 2.0 mm (YTZ ball, manufactured by NIKKATO CORPORATION) was added. The bin was fixed in a shaker (Vibrax VXR basic, manufactured by IKA Company) for dispersing at 1,000 rpm for 24 hours. Thereafter, the obtained liquid dispersion and media were filtered followed by filtering with a PTFE membrane filter having an average pore diameter of 5.0 μm to prepare a pre-pigment dispersion E. The D50 of this pre-pigment dispersion was 110 nm by ELSZ-1000.
Carbon black (SBX45, primary particle diameter of 22 nm, DPB absorption amount of 55 mL/100 g, manufactured by ASAHI CARBON CO., LTD.): 25.3 parts
Pigment dispersant (AJISPER PB821, hydrophobic, Ajinomoto Fine-Techno Co., Inc.): 6.3 parts
Acetone: 68.4 parts

### Pre-Pigment Dispersion F

The following recipe was mixed and placed in a glass screw tube bin (200 ml). Thereafter, 170 parts of zirconia balls having a diameter of 2.0 mm (YTZ ball, manufactured by NIKKATO CORPORATION) was added. The bin was fixed in a shaker (Vibrax VXR basic, manufactured by IKA Company) for dispersing at 1,000 rpm for 24 hours. Thereafter, the obtained liquid dispersion and media were filtered followed by filtering with a PTFE membrane filter having an average pore diameter of 5.0 μm to prepare a pre-pigment dispersion F. The D50 of this pre-pigment dispersion was 110 nm by ELSZ-1000.
Carbon black (SBX45, primary particle diameter of 22 nm, DPB absorption amount of 55 mL/100 g, manufactured by ASAHI CARBON CO., LTD.): 31.6 parts
Pigment dispersant (AJISPER PB821, hydrophobic, Ajinomoto Fine-Techno Co., Inc.): 7.9 parts
Methylethyl ketone: 60.5 parts

### Pre-Pigment Dispersion G

The following recipe was mixed and placed in a glass screw tube bin (200 ml). Thereafter, 170 parts of zirconia balls having a diameter of 2.0 mm (YTZ ball, manufactured by NIKKATO CORPORATION) was added. The bin was fixed in a shaker (Vibrax VXR basic, manufactured by IKA Company) for dispersing at 1,000 rpm for 24 hours. Thereafter, the obtained liquid dispersion and media were filtered followed by filtering with a PTFE membrane filter having an average pore diameter of 5.0 μm to prepare a pre-pigment dispersion G. The D50 of this pre-pigment dispersion was 110 nm by ELSZ-1000.
Carbon black (SBX45, primary particle diameter of 22 nm, DPB absorption amount of 55 mL/100 g, manufactured by ASAHI CARBON CO., LTD.): 25.3 parts
Pigment dispersant (AJISPER PB821, hydrophobic, Ajinomoto Fine-Techno Co., Inc.): 6.3 parts
Ethyl acetate: 68.4 parts

### Pre-Pigment Dispersion H

The following recipe was mixed and placed in a glass screw tube bin (200 ml). Thereafter, 170 parts of zirconia balls having a diameter of 2.0 mm (YTZ ball, manufactured by NIKKATO CORPORATION) was added. The bin was fixed in a shaker (Vibrax VXR basic, manufactured by IKA Company) for dispersing at 1,000 rpm for 24 hours. Thereafter, the obtained liquid dispersion and media were filtered followed by filtering with a PTFE membrane filter having an average pore diameter of 5.0 μm to prepare a pre-pigment dispersion H. The D50 of this pre-pigment dispersion was 110 nm by ELSZ-1000.
Carbon black (SBX45, primary particle diameter of 22 nm, DPB absorption amount of 55 mL/100 g, manufactured by ASAHI CARBON CO., LTD.): 31.6 parts
Pigment dispersant (AJISPER PB821, hydrophobic, Ajinomoto Fine-Techno Co., Inc.): 7.9 parts
Tetrahydrofuran: 12.1 parts
Methylethyl ketone: 48.4 parts

Preparation Examples using the aqueous dispersions 1 to 11 and the ink 1 to 9 using the aqueous dispersions are described below.

The properties of the aqueous dispersions and the inks were evaluated. The results are shown in Table 1.

### Example 1

### Preparation of Aqueous Dispersion 1

A total of 60 g of the pre-pigment dispersion A and 30 g of polyester α were added to a 0.3 litter separable flask equipped with a three one motor, an anchor wing, and a thermocouple in such a manner that the ratio (P/R) of the pigment (P) to the polyester (R) was 0.5 followed by mixing and stirring at 40 degrees C. to obtain a pigment-dispersed resin solution. Next, the liquid was purged of tetrahydrofuran under a reduced pressure in such a manner that the ratio (R/S) of the polyester to tetrahydrofuran (S: solvent) was 1.8. A total of 1.1 g of triethyl amine equivalent to the carboxyl group was added to neutralize the acid value of the polyester followed by mixing and stirring for 0.5 hours. While stirring at 350 rpm, 64 g of deionized water was added dropwise at 15 ml/min followed by a 20 minute stirring to obtain an emulsion. The emulsion was purged of tetrahydrofuran under a reduced pressure followed by filtering with a nylon net having an opening of 67 μm. The solid component of the resulting substance was adjusted with deionized water to 30 percent to obtain an aqueous dispersion 1 containing pigment-enclosed resin particles in which all the surface of the pigment was covered with a resin layer having a thickness of 5 nm or more and which had at least two primary pigment particles.

FIG. 1 is a TEM image illustrating the aqueous dispersion 1 containing pigment-enclosed resin particles produced in Example 1.

### Preparation of Ink 1

The ink of the following recipe was adjusted to have a viscosity of 7.5 mPa·s at 25 degrees C. using the aqueous dispersion 1 followed by filtering with a membrane filter having an average pore diameter of 10 μm to prepare Ink 1.

### Ink Recipe

Aqueous dispersion 1 (solid): 10.75 percent
Propylene glycol (prepared to have a viscosity of 7.5 mPa·s): about 40 percent
Silicone-based surfactant (Silface SAG503A, manufactured by Nissin Chemical co., ltd.): 1.0 percent
Aliphatic dialcohol-based surfactant (Surfynol AD01, manufactured by Nissin Chemical co., ltd.): 0.1 percent
Water: Balance
   Total: 100 percent

### Example 2

### Preparation of Aqueous Dispersion 2

A total of 33.2 g of the pre-pigment dispersion B and 30 g of polyester α were added to a 0.3 litter separable flask equipped with a three one motor, an anchor wing, and a thermocouple in such a manner that the ratio (P/R) of the pigment (P) to the polyester (R) was 0.35 followed by mixing and stirring at 40 degrees C. to obtain a pigment-dispersed resin solution. A total of 1.1 g of triethylamine equivalent to carboxyl group to neutralize the acid value of the polyester was added followed mixing and stirring for 0.5 hours. While stirring at 350 rpm, 64 g of deionized water was added dropwise at 15 ml/min followed by a 20 minute stirring to obtain an emulsion. The emulsion was purged of tetrahydrofuran and methylethyl ketone under a reduced pressure followed by filtering with a nylon net having an opening of 67 μm. The solid component of the resulting substance was adjusted with deionized water to 30 percent to obtain an aqueous dispersion 2 containing pigment-enclosed resin particles in which all the surface of the pigment was covered with a resin layer having a thickness of 5 nm or more and which had at least two primary pigment particles.

### Preparation of Ink 2

Ink 2 was prepared in the same manner as in the manufacturing of Ink 1 except that the aqueous dispersion 2 was used instead of the aqueous dispersion 1.

### Example 3

### Preparation of Aqueous Dispersion 3

A total of 33.2 g of the pre-pigment dispersion C and 30 g of polyester α were added to a 0.3 litter separable flask equipped with a three one motor, an anchor wing, and a thermocouple in such a manner that the ratio (P/R) of the pigment (P) to the polyester (R) was 0.35 followed by mixing and stirring at 40 degrees C. to obtain a pigment-dispersed resin solution. A total of 1.1 g of triethylamine equivalent to carboxyl group to neutralize the acid value of the polyester was added followed mixing and stirring for 0.5 hours. While stirring at 350 rpm, 64 g of deionized water was added dropwise at 15 ml/min followed by a 20 minute stirring to obtain an emulsion. The emulsion was purged of tetrahydrofuran and methylethyl ketone under a reduced pressure followed by filtering with a nylon net having an opening of 67 μm. The solid component of the resulting substance was adjusted with deionized water to 30 percent to obtain an aqueous dispersion 3 containing pigment-enclosed resin particles in which all the surface of the pigment was covered with a resin layer having a thickness of 5 nm or more and which had at least two primary pigment particles.

### Preparation of Ink 3

Ink 3 was prepared in the same manner as in the manufacturing of Ink 1 except that the aqueous dispersion 3 was used instead of the aqueous dispersion 1.

Example 4

### Preparation of Aqueous Dispersion 4

A total of 33.2 g of the pre-pigment dispersion D and 30 g of polyester α were added to a 0.3 litter separable flask equipped with a three one motor, an anchor wing, and a thermocouple in such a manner that the ratio (P/R) of the pigment (P) to the polyester (R) was 0.35 followed by mixing and stirring at 40 degrees C. to obtain a pigment-dispersed resin solution. A total of 1.1 g of triethylamine equivalent to carboxyl group to neutralize the acid value of the polyester was added followed mixing and stirring for 0.5 hours. While stirring at 350 rpm, 64 g of deionized water was added dropwise at 15 ml/min followed by a 20 minute stirring to obtain an emulsion. The emulsion was purged of N-methyl pyrrolidone using an ultra-filtering device followed by filtering with a nylon net having an opening of 67 μm. The solid component of the resulting substance was adjusted with deionized water to 30 percent to obtain an aqueous dispersion 4 containing pigment-enclosed resin particles in which all the surface of the pigment was covered with a resin layer having a thickness of 5 nm or more and which had at least two primary pigment particles.

### Preparation of Ink 4

Ink 4 was prepared in the same manner as in the manufacturing of Ink 1 except that the aqueous dispersion 4 was used instead of the aqueous dispersion 1.

### Example 5

### Preparation of Aqueous Dispersion 5

A total of 60 g of the pre-pigment dispersion E and 30 g of polyester α were added to a 0.3 litter separable flask equipped with a three one motor, an anchor wing, and a thermocouple in such a manner that the ratio (P/R) of the pigment (P) to the resin (R) was 0.5 followed by mixing and stirring at 40 degrees C. to obtain a pigment-dispersed resin solution. Next, the liquid was purged of acetone under a reduced pressure in such a manner that the ratio (R/S) of the polyester to acetone (S: solvent) was 1.8. A total of 1.1 g of triethyl amine equivalent to the carboxyl group was added to neutralize the acid value of the polyester followed by mixing and stirring for 0.5 hours. While stirring at 350 rpm, 64 g of deionized water was added dropwise at 15 ml/min followed by a 20 minute stirring to obtain an emulsion. The emulsion was purged of acetone under a reduced pressure followed by filtering with a nylon net having an opening of 67 μm. The solid component of the resulting substance was adjusted with deionized water to 30 percent to obtain an aqueous dispersion 5 containing pigment-enclosed resin particles in which all the surface of the pigment was covered with a resin layer having a thickness of 5 nm or more and which had at least two primary pigment particles.

### Preparation of Ink 5

Ink 5 was prepared in the same manner as in the manufacturing of Ink 1 except that the aqueous dispersion 5 was used instead of the aqueous dispersion 1.

### Comparative Example 1

### Preparation of Aqueous Dispersion 6

A total of 47.5 g of the pre-pigment dispersion F and 30 g of polyester α were added to a 0.3 litter separable flask equipped with a three one motor, an anchor wing, and a thermocouple in such a manner that the ratio (P/R) of the pigment (P) to the polyester (R) was 0.5 followed by mixing and stirring at 40 degrees C. to obtain a pigment-dispersed resin solution. Next, the liquid was purged of methylethyl ketone under a reduced pressure in such a manner that the ratio (R/S) of polyester to methylethyl ketone (S: solvent) was 1.5. A total of 1.1 g of triethyl amine equivalent to the carboxyl group was added to neutralize the acid value of the polyester followed by mixing and stirring for 0.5 hours. While stirring at 350 rpm, 64 g of deionized water was added dropwise at 15 ml/min followed by a 20 minute stirring to obtain an emulsion. The emulsion was purged of methylethyl ketone under a reduced pressure followed by filtering with a nylon net having an opening of 67 μm. The solid component of the resulting substance was adjusted with deionized water to 30 percent to obtain an aqueous dispersion 6 containing pigment-enclosed resin particles in which all the surface of the pigment was covered with a resin layer having a thickness of 5 nm or more and which had at least two primary pigment particles.

### Preparation of Ink 6

Ink 6 was prepared in the same manner as in the manufacturing of Ink 1 except that the aqueous dispersion 6 was used instead of the aqueous dispersion 1.

### Comparative Example 2

### Preparation of Aqueous Dispersion 7

A total of 60 g of the pre-pigment dispersion G and 30 g of polyester α were added to a 0.3 litter separable flask equipped with a three one motor, an anchor wing, and a thermocouple in such a manner that the ratio (P/R) of the pigment (P) to the polyester (R) was 0.5 followed by mixing and stirring at 40 degrees C. to obtain a pigment-dispersed resin solution. Next, the liquid was purged of ethyl acetate under a reduced pressure in such a manner that the ratio (R/S) of the polyester to ethyl acetate (S: solvent) was 1.8. A total of 1.1 g of triethyl amine equivalent to the carboxyl group was added to neutralize the acid value of the polyester followed by mixing and stirring for 0.5 hours. While stirring at 350 rpm, 64 g of deionized water was added dropwise at 15 ml/min followed by a 20 minute stirring. Consequently, an equalized emulsion was not formed.

### Comparative Example 3

### Preparation of Aqueous Dispersion 8

A total of 33.2 g of the pre-pigment dispersion H and 30 g of polyester α were added to a 0.3 litter separable flask equipped with a three one motor, an anchor wing, and a thermocouple in such a manner that the ratio (P/R) of the pigment (P) to the polyester (R) was 0.35 followed by mixing and stirring at 40 degrees C. to obtain a pigment-dispersed resin solution. A total of 1.1 g of triethylamine equivalent to carboxyl group to neutralize the acid value of the polyester was added followed mixing and stirring for 0.5 hours. While stirring at 350 rpm, 64 g of deionized water was added dropwise at 15 ml/min followed by a 20 minute stirring to obtain an emulsion. The emulsion was purged of tetrahydrofuran and methylethyl ketone under a reduced pressure followed by filtering with a nylon net having an opening of 67 μm. The solid component of the resulting substance was adjusted with deionized water to 30 percent to obtain an aqueous dispersion 8 containing pigment-enclosed resin particles in which all the surface of the pigment was covered with a resin layer having a thickness of 5 nm or more and which had at least two primary pigment particles.

### Preparation of Ink 7

Ink 7 was prepared in the same manner as in the manufacturing of Ink 1 except that the aqueous dispersion 8 was used instead of the aqueous dispersion 1.

### Comparative Example 4

### Preparation of Aqueous Dispersion 9

A total of 10.5 g of carbon black (SBX 45, primary particle diameter of 22 nm, DPB absorption of 55 mL/100 g, manufactured by ASAHI CARBON CO., LTD.), 30 g of polyester a, and 21.4 g of tetrahydrofuran were added to a 0.3 litter separable flask equipped with a three one motor, an anchor wing, and a thermocouple in such a manner that the ratio (P/R) of the pigment (P) to the polyester (R) was 0.35 followed by mixing and stirring at 40 degrees C. to obtain a pigment-dispersed resin solution. A total of 1.1 g of triethylamine equivalent to carboxyl group to neutralize the acid value of the polyester was added followed mixing and stirring for 0.5 hours. While stirring at 350 rpm, 64 g of deionized water was added dropwise at 15 ml/min followed by a 20 minute stirring to obtain an emulsion. The emulsion was purged of tetrahydrofuran and methylethyl ketone under a reduced pressure followed by filtering with a nylon net having an opening of 67 μm. Aqueous dispersion 9 was obtained by adjusting the solid content of the deionized water to 30 percent. Since what was obtained was coarse particles, the aqueous dispersion was not subjected to the particle diameter evaluation. They were not discharged by inkjetting.

### Comparative Example 5

### Preparation of Master Batch (M.B.)

A total of 570 parts of the polyester β and 430 parts of carbon black (SBX45, primary particle diameter of 22 m, DPB absorption of 55 ml/100 g, manufactured by ASAHI CARBON CO., LTD.) were preliminarily mixed with a Henshel mixer (manufactured by NIPPON COKE & ENGINEERING CO., LTD.). The mixture was melt-kneaded with a twin-shaft extruder followed by pulverization to obtain a master batch (M.B.).

### Preparation of Aqueous Dispersion 10

A total of 13 g of M.B. (5.6 g of pigment and 7.4 g of polyester), 20.6 g of polyester α, and 20 g of methylethyl ketone were mixed and stirred at 40 degrees C. in a 0.3 litter separable flask equipped with a three one motor, an anchor wing, and a thermocouple to obtain a pigment-dispersed resin solution having a mass ratio (P/R) of 0.2. A total of 1.0 g of triethylamine equivalent to carboxyl group to neutralize the acid value of the polyester was added followed mixing and stirring for 0.5 hours. While stirring at 350 rpm, 65 g of deionized water was added dropwise at 15 ml/min followed by a 20 minute stirring to obtain an emulsion. The emulsion was purged of methylethyl ketone followed by filtering with a nylon net having an opening of 67 μm. The solid component of the resulting substance was adjusted with deionized water to 30 percent to obtain an aqueous dispersion 10 containing pigment-enclosed resin particles in which all the surface of the pigment was covered with a resin layer having a thickness of 5 nm or more and which had at least two primary pigment particles.

### Preparation of Ink 8

### Ink 8 was prepared in the same manner as in the manufacturing of Ink 1 except that the aqueous dispersion 10 was used instead of the aqueous dispersion 1.

### Comparative Example 6

Instead of the pigment-enclosed resin particles, a polyester alone resin emulsion and aqueous dispersion 11 were prepared in the following manner to prepare ink 9.

### Polyester Alone Resin Emulsion

A total of 25 g of the polyester α and 14 g of tetrahydrofuran were mixed and stirred at 40 degrees C. in a 0.3 litter separable flask equipped with a three one motor, an anchor wing, and a thermocouple to obtain a resin solution. A total of 0.84 g of triethylamine equivalent to carboxyl group was then added to neutralize the acid value of the polyester followed stirring for 20 minutes. While stirring at 350 rpm, 53 g of deionized water was dripped at 15 ml/min followed by a 20 minute stirring to obtain an emulsion. The emulsion was purged of tetrahydrofuran under a reduced pressure followed by filtering with a nylon net having an opening of 67 μm. The solid content was adjusted to 30 percent with deionized water to obtain a polyester alone resin emulsion having a D50 of 65 nm.

### Preparation of Aqueous Dispersion 11

A total of 62.0 parts of 1,6-hexane diol (manufactured by Tokyo Chemical Industry Co. Ltd.) was dissolved in 700 ml of dichloromethane. Next, 20.7 parts of pyridine (manufactured by Tokyo Chemical Industry Co. Ltd.) was added to the solution followed by stirring. To this solution, a solution in which 50.0 parts of 2-naphthalene carbonyl chloride (manufacture by Tokyo Chemical Industry Co. Ltd.) was dissolved in 100 ml of dichloromethane (manufactured by Tokyo Chemical Industry Co. Ltd.) was added dropwise in two hours followed by stirring at room temperature for six hours. The reaction solution was rinsed with water and thereafter the organic phase was isolated followed by drying with magnesium sulfate and the solvent was distilled away. The residue was purified by silica gel column chromatography with a solvent mixture of dichloromethane and methanol at a volume ratio of 98:2 as an eluent to obtain a compound.

Next, 42.1 parts of the obtained compound was dissolved in 80 ml of dried methylethylketone followed by heating at 60 degrees C. while being stirred. To the resulting solution, a solution in which 24.0 parts of KARENZ™ MOI (methylethyl ketone Showa Denko K.K.) was dissolved in 20 ml of dried methylethyl ketone was added dropwise in one hour followed by stirring at 70 degrees C. for 12 hours. After being cooled down to room temperature, the solvent was distilled away. The residue was purified by silica gel column chromatography with a solvent mixture of dichloromethane and methanol at a volume ratio of 99:1 as an eluent to obtain a monomer.

Next, 2.30 parts of acrylic acid (manufactured by Tokyo Chemical Industry Co. Ltd.), 8.54 parts of the monomer, and 0.31 parts of 2,2′-azobis(isobutylonitrile) (manufactured by Tokyo Chemical Industry Co. Ltd.) were dissolved in 100 ml of methylethyl ketone. The solution thus obtained was stirred at 75 degrees C. for five hours in a nitrogen atmosphere. Thereafter, the reaction solution was cooled down to room temperature and precipitated five times using hexane to purify a copolymer. Thereafter, the purified copolymer was filtered followed by drying under a reduced pressure to obtain a pigment dispersant.

A total of 3.8 parts of the pigment dispersant was dissolved in 30.0 parts of diethanol amine aqueous solution in such a manner that pH was 8.0. Moreover, deionized water was added to make the total amount of the aqueous solution 45.0 parts. Next, 15.0 parts of carbon black (SBX45, manufactured by ASAHI CARBON CO., LTD.) was admixed followed by placing in a glass screw tube bin (110 ml). Thereafter, 170 parts of zirconia balls having a diameter of 2.0 mm (YTZ ball, manufactured by NIKKATO CORPORATION) was added. The bin was fixed in a shaker (Vibrax VXR basic, manufactured by IKA Company) for dispersing at 1,000 rpm for 24 hours. Thereafter, the obtained liquid dispersion and media were filtered followed by filtering with an acetic acid cellulose membrane filter having an average pore diameter of 5.0 μm to prepare an aqueous dispersion 11. The D50 of this aqueous dispersion 11 was 120 nm by ELSZ-1000. No form of covering all the surface of the pigment with a resin layer was present in the image obtained by a TEM.

### Preparation of Ink 9

The ink of the following recipe was adjusted to have a viscosity of 7.5 mPa·s at 25 degrees C. using the polyester alone resin emulsion and the aqueous dispersion followed by filtering with a membrane filter having an average pore diameter of 10 μm to prepare Ink 9 having the following recipe.

### Ink Recipe

Polyester alone resin emulsion (solid content): 5.375 percent
Aqueous dispersion 11 (solid content): 5.375 percent
Propylene glycol (prepared to have a viscosity of 7.5 mPa·s): about 40 percent
Silicone-based surfactant (Silface SAG503A, manufactured by Nissin Chemical co., ltd.): 1.0 percent
Aliphatic dialcohol-based surfactant (Surfynol AD01, manufactured by Nissin Chemical co., ltd.): 0.1 percent
Water: Balance
   Total: 100 percent

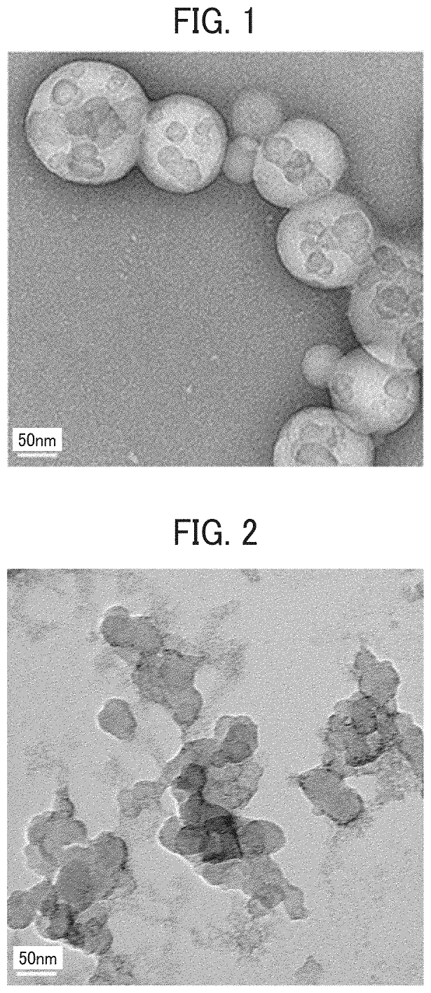

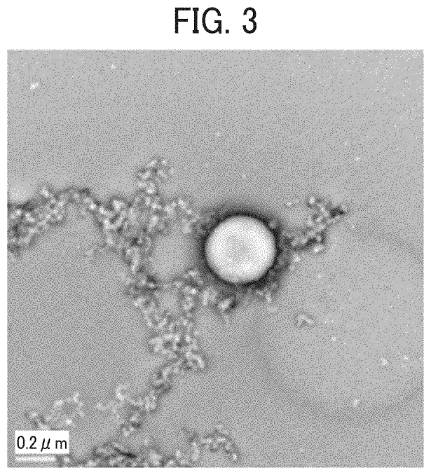

FIG. 2 is a TEM image illustrating the aqueous dispersion 11 containing the pigment-enclosed resin particles prepared in Comparative Example 6.FIG. 3 is a TEM image of ink 9.

### Method of Evaluating Aqueous Dispersion

### Molecular Weight

Device: GPC (manufactured by TOSOH CORPORATION, detector: RI, measuring temperature: 40 degrees C.
Mobile phase: Tetrahydrofuran, flow rate: 0.45 mL/min.

The number average molecular weight (Mn), weight average molecular weight (Mw), and molecular weight distribution (Mw/Mn) are each measured by gel permeation chromatography (GPC) using a calibration curve prepared based on a polystyrene sample having a known molecular weight as reference. The column used was composed of those connected in serial, each having an exclusion limit of 60,000, 20,000, and 10,000.

### Cumulative Volume Particle Diameters D50 and D90

The D50 of the pre-pigment dispersion was measured by a dynamic light scattering method using a zeta potential⋅ particle size measuring system (ELSZ-1000, manufactured by OTSUKA ELECTRONICS Co., LTD.). Specifically, a sample for measurement was diluted with deionized water and optionally an organic solvent to have a solid content concentration of 0.01 weight percent. The obtained solution was placed in a quartz cell. The cell was placed in a sample holder. Thereafter, the sample was measured under the conditions of a temperature at 25 degrees C., dust cut (5 times, Upper: 5, Lower: 100), and number of repeated times of 70.

The D50, D90, and the volume frequency (percent) in a region of a particle size of from 1 to 50 μm of the aqueous dispersion containing pigment-enclosed resin particles were measured by a laser diffraction scattering particle diameter distribution measuring device (LA-960, manufactured by HORIBA, Ltd.). Specifically, the sample was diluted with deionized water to have a transmission ratio R of semiconductor laser beams and a transmission ratio B of light emitting diode (LED) light at the measurement by the device mentioned above of from 30 to 70 percent. A part of the solution obtained was placed in a batch cell (spacer of 50 μm), which was then placed in a sample holder.

### Abundance Ratio of Coarse Particle

The number of coarse particles in an aqueous dispersion containing pigment-enclosed resin particles was measured by a laser diffraction scattering particle diameter distribution measuring device (LA-960, manufactured by HORIBA, Ltd.).

Specifically, the sample was diluted with deionized water to have a transmission ratio R of semiconductor laser beams and a transmission ratio B of light emitting diode (LED) light at the measurement by the device mentioned above of from 30 to 70 percent. A part of the solution obtained was placed in a batch cell (spacer of 50 μm), which was then placed in a sample holder. The total frequency (percent) of particles having a particle diameter of from 1 to 50 μm in the volume frequency distribution was determined as the abundance ratio of coarse particles based on the measuring results.

### Pigment Exposure Ratio

The pigment exposure ratio was calculated based on the amount of pigments exposed to the surface of coated film observed by an SEM. Specifically, an aqueous dispersion or ink is prepared using deionized water to achieve a solid content concentration of 10.75 percent. This aqueous dispersion is applied to coated paper (LumiArt Gloss 130) with a 0.15 mm bar coater followed by drying at 25 degrees C. for one night. This dried coating film is cut out and fixed onto a stub for SEM observation with carbon tape. This fixed film is observed without electroconductivity treatment with an SEM (Merlin, manufactured by ZEISS) equipped with a reflected electron detector at an acceleration voltage of 0.75 kV and 2,000 to 20,000× magnification. Exposed pigments of carbon black can be discerned from the resin based on the difference in the emission amount of reflected electrons between them. The ratio of the area occupied by the pigment to the entire surface of coated film at 20,000× magnification was defined as the pigment exposure ratio, which was classified as follows. The ratio of the area of the pigment in the entire surface of the coated film was obtained by digitization of the SEM image. The ratios in three fields of vision obtained by arbitrarily changing the observation points were averaged.

### Surface Roughness

The surface roughness was calculated as follows using a scanning probe microscope (SPM). An aqueous dispersion containing pigment-enclosed resin particles having a solid content concentration of 10.75 percent by mass was prepared using deionized water. This aqueous dispersion was applied to coated paper (LumiArt Gloss 130) with a 0.15 mm bar coater followed by drying at 100 degrees C. in an oven for five minutes. This coated film was cut out followed by observation under the following conditions to calculate the surface roughness. The film was observed in three fields of vision to obtain the average of the surface roughness values.
Instrument: SPM (DimensionIcon, manufactured by Bruker)
Cantilever: OMCL-AC240TS, manufactured by Olympus Corporation
Measurement mode: tapping mode
Observation region: 2 μm square

### Abundance Ratio of Pigment-enclosed Resin Particles

The abundance ratio of pigment-enclosed resin particles was evaluated based on the observation as follows. Resin particles containing pigment-enclosed resin particles are diluted with deionized water to obtain a liquid sample having a solid content concentration of 0.1 percent. Next, 1 μl of the liquid sample is placed on a hydrophillized-collodion-film attached mesh (Cu 150 mesh, manufactured by NISSIN EM CO., LTD.) using a micro pipette. Immediately thereafter, the liquid is absorbed by a filter paper cut in the shape of a triangle. Next, 1 μl of Em stainer diluted with a factor of 10 is placed on the mesh. Immediately thereafter, the liquid is absorbed by filter paper cut in the shape of a triangle. Subsequent to drying under a reduced pressure, the sample remaining on the mesh is observed with a TEM (JEM-2100F, manufactured by JEOL Ltd.) at an acceleration voltage of 200 kV and 40,000× magnification. According to this observation method, five or more images each having at least three particles of 50 nm or greater are obtained while arbitrarily changing fields of vision. The ratio of the number of pigment-enclosed resin particles to the particles of 50 nm or greater is calculated for each image. The average of the ratios is calculated. This average is defined as the abundance ratio of pigment-enclosed resin particles in particles.

### Average Aspect Ratio

The aspect ratio of pigment-enclosed resin particles was obtained by image processing of images of particles obtained by observing the pigment-enclosed resin particles using the TEM mentioned above. In fact, while changing observation points, multiple images including pigment-enclosed resin particles were obtained in different fields of vision. Pigment-enclosed resin particles without overlapping other particles were extracted by digitization using image analysis software (ImageJ, created by National Institutes of Health) followed by particle analysis. The ratio of the major axis to the minor axis of the ellipse most approximate to a particle was determined as the aspect ratio. The aspect ratios of 20 particles were used to calculate the average thereof.

### Dispersion Stability of Aqueous Dispersion

Specifically, each aqueous dispersion was placed in a glass screw tube to achieve a solid content concentration of 10.75 percent using deionized water. The mixture was allowed to rest at 40 degrees C. for one week. The dispersion stability of the precipitate present at the bottom of the screw tube was evaluated according to the following criteria. The precipitate at the bottom of the tube was visually checked after the tube was turned upside down without vibration and allowed to rest for one hour. The re-dispersibility was checked by vibration for 10 seconds using a VORTEX Genius 3 (manufactured by IKA) at a dial of 4.

### Evaluation Criteria

S: no precipitate present
A: particulate precipitate slightly present but re-dispersible
B: particulate precipitate significantly present but re-dispersible
C: no re-dispersible precipitate present

### Method of Evaluating Ink

The optical density was evaluated for each of the prepared inks in the following manner. The results are shown in Table 1.

### Method of Outputting Image

The exterior of an inkjet printer (IPSiO Gxe 5500, manufactured by Ricoh Company Ltd.) was removed and multiple bypass feeders were attached on the rear side. Pure water (cleaning liquid) was allowed to sufficiently flow in the ink supplying passage including the print head until the cleaning liquid was not colored. Thereafter, the cleaning liquid was completely removed from the device, which was used for evaluation.

An ink cartridge was filled with the prepared ink and used as the ink cartridge for evaluation. After conducting a filling operation and confirming that all the nozzles were filled with the ink for evaluation and no defective images were produced, “gloss and beautiful mode” was selected by a driver that was installed onto the printer. Thereafter, “color matching off” was determined as print mode at user settings. The amount of ink discharged in this mode was adjusted by changing the drive voltage of the head so that the amount of the ink present in the solid image on a recording medium was 20 g/m².

### Optical Density

Two solid images were printed according to the method mentioned above. One of them was dried at room temperature of 25 degrees C. for one day and the other was dried by heating at 100 degrees C. in an oven for five minutes.

The whole density of the printed images placed on white plain paper was measured by a spectrophotometer (X-Rite 939). The value of K was defined as the optical density.

The difference ΔOD (OD₂₅-OD₁₀₀) was calculated from the optical density (OD₂₅) obtained from drying at 25 degrees C. and the optical density (OD₁₀₀) obtained from drying at 100 degrees C. This ΔOD was evaluated according to the following evaluation criteria.

### Evaluation Criteria

A: Less than zero
B: Zero
C: Greater than zero

TABLE 1

| | | Example | | | | |
|---|---|---|---|---|---|---|
| | | 1 | 2 | 3 | 4 | 5 |
| Ink No. | | 1 | 2 | 3 | 4 | 5 |
| Aqueous dispersion No. | | 1 | 2 | 3 | 4 | 5 |
| Type of pre-pigment | | A | B | C | D | E |
| dispersion | | | | | | |
| Recipe | Type of | THF | THF/ | THF/ | NMP | Acetone |
| | solvent | | MEK | MEK | | |
| | (ratio) | | (80/20) | (50/50) | | |
| | Pigment/ | 0.5 | 0.35 | 0.35 | 0.35 | 0.5 |
| | resin (P/R) | | | | | |
| | Resin/ | 1.8 | 1.5 | 1.5 | 1.5 | 1.8 |
| | solvent (R/S) | | | | | |
| Pigment- | 50 percent | 77 | 85 | 102 | 86 | 91 |
| enclosed | cumulative | | | | | |
| resin | volume | | | | | |
| particles | particle | | | | | |
| | diameter | | | | | |
| | (D50) (nm) | | | | | |
| | 90 percent | 110 | 165 | 390 | 260 | 480 |
| | cumulative | | | | | |
| | volume | | | | | |
| | particle | | | | | |
| | diameter | | | | | |
| | (D90) (nm) | | | | | |
| | Coarse | 0 percent | 0 percent | 0.5 percent | 2 percent | 3 percent |
| | particle (1 to | | | | | |
| | 50 μm) | | | | | |
| | (abundance | | | | | |
| | ratio) | | | | | |
| | (percent) | | | | | |
| | Average | 1.0 | 1.1 | 1.1 | 1.1 | 1.2 |
| | aspect ratio | | | | | |
| | Abundance | 89 | 49 | 48 | 49 | 85 |
| | ratio | | | | | |
| | (percent) of | | | | | |
| | pigment- | | | | | |
| | enclosed | | | | | |
| | resin particles | | | | | |
| | (TEM) | | | | | |
| | Pigment | 0 | 0 | 0 | 0 | 4 |
| | exposure | | | | | |
| | ratio | | | | | |
| | (percent) | | | | | |
| | (SEM) | | | | | |
| | Dispersion | S | S | A | A | A |
| | stability | | | | | |
| Image quality | Image | 2.3 | 2.2 | 2.1 | 2.1 | 1.7 |
| | density | | | | | |
| | (OD₂₅) | | | | | |
| | Image | 2.7 | 2.5 | 2.4 | 2.5 | 2.4 |
| | density | | | | | |
| | (OD₁₀₀) | | | | | |
| | ΔOD (OD₂₅- | A | A | A | A | A |
| | OD₁₀₀) | | | | | |
| | Surface | 2 | 2 | 4 | 3 | 9 |
| | roughness | | | | | |
| | (drying at | | | | | |
| | 100 degrees | | | | | |
| | C.) (nm) | | | | | |

| | | Comparative Example | | | | | |
|---|---|---|---|---|---|---|---|
| | | 1 | 2 | 3 | 4 | 5 | 6 |
| Ink No. | | 6 | — | 7 | — | 8 | 9 |
| Aqueous dispersion No. | | 6 | 7 | 8 | 9 | 10 | 11 |
| Type of pre-pigment | | F | G | H | — | — | — |
| dispersion | | | | | | | |
| Recipe | Type of solvent | MEK | Ethyl | THF/ | THF | THF | — |
| | (ratio) | | acetate | MEK | | | |
| | | | | (20/80) | | | |
| | Pigment/resin | 0.5 | 0.5 | 0.35 | 0.35 | 0.2 | |
| | (P/R) | | | | | | |
| | Resin/solvent | 1.5 | 1.8 | 1.5 | 1.4 | 1.4 | |
| | (R/S) | | | | | | |
| Pigment- | 50 percent | 129 | — | 124 | — | 360 | |
| enclosed | cumulative | | | | | | |
| resin | volume | | | | | | |
| particles | particle | | | | | | |
| | diameter (D50) | | | | | | |
| | (nm) | | | | | | |
| | 90 percent | 610 | — | 510 | — | 1500 | |
| | cumulative | | | | | | |
| | volume | | | | | | |
| | particle | | | | | | |
| | diameter (D90) | | | | | | |
| | (nm) | | | | | | |
| | Coarse particle | 6 percent | — | 2 percent | — | 65 percent | |
| | (1 to 50 μm) | | | | | | |
| | (abundance | | | | | | |
| | ratio) (percent) | | | | | | |
| | Average aspect | 1.1 | — | 1.2 | — | 1.8 | |
| | ratio | | | | | | |
| | Abundance | 88 | — | 88 | — | 33 | 0 |
| | ratio (percent) | | | | | | |
| | of pigment- | | | | | | |
| | enclosed resin | | | | | | |
| | particles | | | | | | |
| | (TEM) | | | | | | |
| | Pigment | 3 | — | 3 | — | 0 | 17 |
| | exposure ratio | | | | | | |
| | (percent) | | | | | | |
| | (SEM) | | | | | | |
| | Dispersion | B | — | B | — | C | A |
| | stability | | | | | | |
| Image | Image density | 1.9 | — | 1.9 | — | 1.8 | 2 |
| quality | (OD₂₅) | | | | | | |
| | Image density | 2.2 | — | 2.3 | — | 1.8 | 1.5 |
| | (OD₁₀₀) | | | | | | |
| | ΔOD (OD₂₅- | A | — | A | — | B | C |
| | OD₁₀₀) | | | | | | |
| | Surface | 7 | — | 5 | — | 10 | 79 |
| | roughness | | | | | | |
| | (drying at 100 | | | | | | |
| | degrees C.) | | | | | | |
| | (nm) | | | | | | |

The present disclosure relates to the aqueous dispersion of the following 1 and also includes the following 2 to 15 as embodiments.

1. An aqueous dispersion contains resin particles containing a resin, wherein the resin particles contains pigment-enclosed resin particles containing an inorganic pigment enclosed in the resin, wherein the pigment-enclosed resin particles have a 50 percent cumulative volume particle diameter (D50) of from 40 to 200 nm and a 90 percent cumulative volume particle diameter (D90) of from 70 to 500 nm as measured by laser diffraction scattering, wherein the pigment-enclosed resin particles have an average aspect ratio of from 1.0 to 1.5.

2. The aqueous dispersion according to 1 mentioned above, wherein the total frequency of the pigment-enclosed resin particles having a particle diameter of from 1 to 50 μm in a volume frequency distribution obtained by laser diffraction scattering is 1.0 percent or less.

3. The aqueous dispersion according to 1 or 2 mentioned above, wherein the 90 percent cumulative volume particle diameter (D90) is from 70 to 300 nm.

4. The aqueous dispersion according to any one of 1 to 3 mentioned above, wherein the mass ratio of the inorganic pigment to the resin is from 0.20 to 0.75, wherein the pigment exposure ratio is 8 percent or less as calculated in the following manner: the aqueous dispersion containing pigment-enclosed resin particles is adjusted to have a solid content concentration of 10.75 percent by mass; the aqueous dispersion is applied to coated paper followed by drying at 25 degrees C. to obtain a coated film; the coated film is not subjected to electroconductivity treatment and observed by a scanning electron microscope equipped with back-scattered electron detector at an acceleration voltage of 0.75 kV and 20,000× magnification to obtain an image; an image of the coated film observed is digitized to calculate the inorganic pigment area thereof; and the ratio of the inorganic pigment at the surface of the coated film is determined as the pigment exposure ratio.

5. The aqueous dispersion according to any one of 1 to 4 mentioned above further contains an antioxidant.

6. The aqueous dispersion according to any one of 1 to 5 mentioned above, wherein the inorganic pigment contains carbon black.

7. The aqueous dispersion according to any one of 1 to 6 mentioned above, wherein the ratio of the pigment-enclosed resin particles is 30 percent by number or greater in the resin particles having a particle diameter of 50 nm or greater.

8. The aqueous dispersion according to any one of 1 to 7 mentioned above, wherein the resin particles contains polyester.

9. The aqueous dispersion according to 8 mentioned above, wherein the polyester is a self-emulsifying resin having a carboxyl group.

10. A method of manufacturing the aqueous dispersion of any one of 1 to 9 mentioned above includes:

mixing a water-miscible organic solvent and a pigment to obtain a pre-pigment dispersion having a 50 percent cumulative volume particle diameter (D50) of from 30 to 120 nm;

mixing the pre-pigment dispersion with a resin to obtain a pigment-dispersed resin solution;

mixing the solution with water to obtain a liquid dispersion containing pigment-enclosed resin particles in which the pigment is enclosed in the resin; and

purging the liquid dispersion of the water-miscible organic solvent to obtain an aqueous dispersion containing the pigment-enclosed resin particles.

11. A method of manufacturing the aqueous dispersion of any one of 1 to 9 mentioned above, includes

mixing a water-miscible organic solvent, a water-immiscible organic solvent, a pigment, and optionally a pigment dispersant under a condition that the proportion of the water-miscible organic solvent to the total mass of the water-miscible organic solvent and the water-immiscible organic solvent is 30 percent by mass or greater to obtain a pre-pigment dispersion having a D50 of from 30 to 120 nm;

mixing the pre-pigment dispersion with a resin to obtain a pigment-dispersed resin solution;

mixing the solution with water to obtain a liquid dispersion containing pigment-enclosed resin particles; and

purging the liquid dispersion of the water-miscible organic solvent and the water-immiscible organic solvent to obtain the aqueous dispersion.

12. The method according to 11 mentioned above, wherein the proportion of the water-miscible organic solvent to the total mass of the water-miscible organic solvent and the water-immiscible organic solvent is 60 percent by mass or greater.

13. The method according to 10 or 11 mentioned above, wherein the water-miscible organic solvent contains a cyclic compound.

14. The method according to 13 mentioned above, wherein the cyclic compound contains a cyclic ether.

15. An ink contains pigment-enclosed resin particles enclosing an inorganic pigment, wherein the pigment-enclosed resin particles have a 50 percent cumulative volume particle diameter (D50) of from 40 to 200 nm and a 90 percent cumulative volume particle diameter (D90) of from 70 to 500 nm as measured by laser diffraction scattering, wherein the resin particles have an average aspect ratio of from 1.0 to 1.5.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. An aqueous dispersion comprising:
water; and
resin particles comprising a resin,
wherein the resin particles comprise pigment-enclosed resin particles comprising an inorganic pigment enclosed in the resin,
wherein the pigment-enclosed resin particles have a 50 percent cumulative volume particle diameter (D50) of from 40 to 200 nm and a 90 percent cumulative volume particle diameter (D90) of from 70 to 500 nm as measured by laser diffraction scattering,
wherein the pigment-enclosed resin particles have an average aspect ratio of from 1.0 to 1.5.

2. The aqueous dispersion according to claim 1,
wherein a total frequency of the pigment-enclosed resin particles having a particle diameter of from 1 to 50 μm in a volume frequency distribution obtained by laser diffraction scattering is 1.0 percent or less.

3. The aqueous dispersion according to claim 1, wherein the 90 percent cumulative volume particle diameter (D90) is from 70 to 300 nm.

4. The aqueous dispersion according to claim 1, wherein a mass ratio of the inorganic pigment to the resin is from 0.20 to 0.75, wherein a pigment exposure ratio is 8 percent or less as calculated in the following manner:
the aqueous dispersion is adjusted to have a solid content concentration of 10.75 percent by mass; the aqueous dispersion is applied to coated paper followed by drying at 25 degrees C. to obtain a coated film; the coated film without an electroconductivity treatment is observed with a scanning electron microscope equipped with back-scattered electron detector at an acceleration voltage of 0.75 kV and 20,000× magnification to obtain an image; the image is digitized to calculate an inorganic pigment area thereof; and a ratio of the inorganic pigment area to a surface of the coated film is determined as the pigment exposure ratio.

5. The aqueous dispersion according to claim 1, further comprising an antioxidant.

6. The aqueous dispersion according to claim 1, wherein the inorganic pigment comprises carbon black.

7. The aqueous dispersion according to claim 1, wherein a ratio of the pigment-enclosed resin particles is 30 percent by number or greater to the resin particles having a particle diameter of 50 nm or greater.

8. The aqueous dispersion according to claim 1, wherein the resin of the resin particles comprise polyester.

9. The aqueous dispersion according to claim 8, wherein the polyester is a self-emulsifying resin having a carboxyl group.

10. A method of manufacturing the aqueous dispersion of claim 1, comprising:
mixing a water-miscible organic solvent and a pigment to obtain a pre-pigment dispersion having a 50 percent cumulative volume particle diameter (D50) of from 30 to 120 nm;
mixing the pre-pigment dispersion with a resin to obtain a pigment-dispersed resin solution;
mixing the pigment-dispersed resin solution with water to obtain a liquid dispersion containing pigment-enclosed resin particles; and
purging the liquid dispersion of the water-miscible organic solvent to obtain the aqueous dispersion.

11. The method according to claim 10,
wherein the water-miscible organic solvent comprises a cyclic compound.

12. The method according to claim 11,
wherein the cyclic compound comprises a cyclic ether.

13. A method of manufacturing the aqueous dispersion of claim 1, comprising:
mixing a water-miscible organic solvent, a water-immiscible organic solvent, and a pigment under a condition that a proportion of the water-miscible organic solvent to a total mass of the water-miscible organic solvent and the water-immiscible organic solvent is 30 percent by mass or greater to obtain a pre-pigment dispersion having a 50 percent cumulative volume particle diameter (D50) of from 30 to 120 nm;
mixing the pre-pigment dispersion with a resin to obtain a pigment-dispersed resin solution;
mixing the pigment-dispersed resin solution with water to obtain a liquid dispersion containing pigment-enclosed resin particles; and
purging the liquid dispersion of the water-miscible organic solvent and the water-immiscible organic solvent to obtain the aqueous dispersion.

14. The method according to claim 13,
wherein the proportion of the water-miscible organic solvent to the total mass of the water-miscible organic solvent and the water-immiscible organic solvent is 60 percent by mass or greater.

15. The method according to claim 13
wherein the water-miscible organic solvent comprises a cyclic compound.

16. The method according to claim 15,
wherein the cyclic compound comprises a cyclic ether.

17. An ink comprising:
pigment-enclosed resin particles comprising a resin and an inorganic pigment enclosed in the resin,
wherein the pigment-enclosed resin particles have a 50 percent cumulative volume particle diameter (D50) of from 40 to 200 nm and a 90 percent cumulative volume particle diameter (D90) of from 70 to 500 nm as measured by laser diffraction scattering,
wherein the resin particles have an average aspect ratio of from 1.0 to 1.5.
